(19) United States
(12) Patent Application Publication
(10) Pub. No.: US 2026/0042055 A1
(43) Pub. Date: Feb. 12, 2026

(54) GAS TREATMENT PROCESS

(71) Applicant: The University of Queensland, St. Lucia (AU)

(72) Inventors: Min Zheng, Indooroopilly (AU); Zhiguo Yuan, Mount Ommaney (AU); Zhetai Hu, St. Lucia (AU); Shihu Hu, St. Lucia (AU)

(21) Appl. No.: 18/998,392

(22) PCT Filed: Jul. 27, 2023
(86) PCT No.: PCT/AU23/50697

§ 371 Date: Jan. 24, 2025

(30) Foreign Application Priority Data
Jul. 27, 2022 (AU) 2022902104

(51) Int. Cl. B01D 53/32; C02F 1/52

(52) U.S. Cl. CPC B01D 53/326; C02F 1/5245; B01D 2256/245; B01D 2257/304; B01D 2257/406; B01D 2257/504; B01D 2258/05; B01D 2259/818

(57) ABSTRACT

A method and a system for removing a portion of at least one contaminant gas from a gas stream is disclosed. The method comprises the steps of: a) applying a voltage across a pair of electrodes in contact with a working fluid to generate a plurality of ions; and b) reacting the at least one contaminant gas with the plurality of ions to convert it to one or more reaction products, thereby sequestering at least some of the contaminant gas from the first gas stream to produce a second gas stream, wherein the pH of the working fluid is substantially maintained at a predetermined set point for improving the efficiency of the conversion. The invention also relates to a process for treating sewage or wastewater by adding the one or more reaction products to: the sewage, wastewater, sludge and/or an anaerobic digester.

### FIELD OF THE INVENTION

The present invention relates to a process for treating sewage or wastewater and a method for purifying a gas stream obtained from said process. In particular, the present invention relates to the electrochemical treatment of said gas stream, such as biogas, to remove at least a portion of a contaminant gas from the gas stream to produce a gas stream which is at least partially purified, that is, enriched in at least one target gas. The invention also relates to a process for producing a slurry of a reaction product from the electrochemical treatment of the gas stream and the use of said slurry to treat sewage, wastewater and/or a sludge derived therefrom.

### BACKGROUND TO THE INVENTION

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of the common general knowledge in the field.

Microbial processes play a central role in wastewater management. In particular, they underpin biological treatment of wastewater; the most cost-effective and environmentally friendly method for wastewater treatment.

A typical biological wastewater treatment plant receives wastewater from sewer networks. The wastewater is first treated to remove large particulates (by screening, or passing through a primary settler, or both). The resulting liquor then passes to a bioreactor(s), where bacteria mineralise any organic carbon (often referred to as biochemical oxygen demand or BOD) present in the wastewater to form CO₂ and convert any ammonia present to nitrate(s), and in some cases further to nitrogen gas. Some bioreactors also achieve biological phosphorus removal. This process results in the formation/growth of biomass. The biomass is then separated from the liquor, typically in a secondary settler.

Part of the sludge separated from the treated water in the secondary settler, often after a thickening process, is then treated in a bioreactor, typically an anaerobic digester or an aerobic digester, sometimes together with any primary sludge that may have resulted from the settling process in the primary settler.

The proliferation of biological wastewater treatment plants (WWTPs) has brought about the production of an increasing amount of wastewater sludge. Anaerobic digestion is a favoured sludge destruction method to stabilise wastewater sludge prior to its disposal. In addition to achieving sludge stabilisation, anaerobic digestion also offers the opportunity to recover organics from a concentrated waste stream as a renewable bioenergy in the form of biogas.

For example, in a typical anaerobic digester, the BOD of the sludge is converted to biogas, comprising methane, carbon dioxide and other gases. Products from the anaerobic digester also include solids that may be disposed of, and a liquid stream. Biogas produced by anaerobic digestion (AD) from any source typically contains methane (CH₄) around 60% (e.g., 50-70%), carbon dioxide (CO₂) around 40% (e.g., 30-50%), and traces of other gases such as hydrogen sulfide (H₂S) and ammonia (NH₃).

### Problems of Biogas

Bioenergy recovery from wastewater by producing biogas is well known and widely implemented in the art, particularly at large wastewater treatment plants. The biogas produced is currently almost exclusively used locally for thermal and electrical energy generation, with the use of combined heat and power (CHP) systems, to meet the heat and electricity requirements of the treatment process. Limited by the price of the local energy supply, the value thus derived from biogas is relatively low, and is often offset by the high capital and maintenance costs of the CHP systems.

Alternative uses for the collected biogas are few and far between. The most promising and valuable potential uses for biogas are as a transport fuel or for injection into the natural gas grids. One of the key issues with compressing and transporting raw biogas, however, is the conversion of the CO₂ component into dry ice under high pressure. This causes substantial freezing issues at metering points and valves in the compression and storage stages of CNG. Accordingly, for biogas to be used as a transportable fuel, it is imperative for the CO₂ component to be substantially removed in a cost-effective manner. Similar consideration can also be made for other impurity gases in the biogas, such as hydrogen sulfide (H₂S) and ammonia (NH₃).

For biogas compression to occur in the conventional manner for transportation purposes, the CO₂ component, which roughly constitutes 30-50% of biogas, needs to be removed to below 5%. The economic benefit of this removal is at least twofold, as the removal of non-combustible gases such as CO₂ would also increase the caloric value of the biogas and expand the range of its application. In this regard, raw biogas (containing CH₄ at roughly 50-70%) with a calorific value typically in the range of 20-25 MJ/m³-biogas, can be treated to approach that of pure CH₄, approximately 36 MJ/m³-CH₄.

Several methods of removing CO₂ from raw biogas (in order to upgrade the raw biogas) are known in the art. These methods typically include physical and/or chemical separation of the CO₂ component from the raw biogas stream. These methods are relatively complex and can be expensive and inconvenient.

For example, the biogas upgrading technology most widely known in the art is high pressure water scrubbing, which selectively dissolves CO₂ from a raw biogas stream, by bringing it into contact with a stream of high-pressure water. This method relies on the comparatively higher solubility of CO₂ than CH₄ in water in order to drive the selective dissolution of the former into the water stream. In some implementations of this technology, organic solvents (e.g., mixtures of methanol and dimethyl ethers of polyethylene glycol) replace water to absorb CO₂, seeking to harness their higher CO₂ saturation concentration, resulting in a significantly higher capacity to dissolve CO₂ per unit volume of solvent.

Other physical upgrading technologies known in the art include pressure swing adsorption, which relies on the use of materials with a high affinity for CO₂ molecules such as carbon molecular sieves, activated carbon and zeolites, membrane separation to separate CO₂ retentate using selective permeability, and cryogenic separation of liquified CO₂.

Chemical methods for removing CO₂ from a feed gas include contacting the feed gas with a variety of solvents, gases and solutions including amine, hydroxides, and alkaline salts in order to chemically react with CO₂ and remove CO₂ from the gas feed. One such system includes dissolving gaseous CO₂ into a solution by gas-liquid contacting, from which the CO₂ is removed by precipitating them out of solution in the form of an insoluble carbonate salt. In this ionic reaction-based regime, sourcing and delivering cations that promote carbonate precipitation is a key factor to the economic feasibility and practically of the biogas upgrading system.

Furthermore, a more direct catalyst-driven hydrogenation of CO₂ can reduce this gas to CH₄, thereby achieving biogas upgrading and an effective methane-enrichment of the feed gas. While chemically direct, this catalytic hydrogenation process requires exposing consumable catalysts based on costly nickel and ruthenium alloys to severe reaction conditions comprising high temperatures (around 300° C.) and pressures (around 5-20 MPa).

Methods of biologically converting CO₂ are also known. In a microbial process, hydrogenotrophic methanogens and homoacetogens can reduce CO₂ to CH₄ in the presence of H₂ as an electron donor. This may be a potentially cost-effective method in the future.

While the conventional physical and chemical technologies outlined can be relatively efficient, especially compared to the biological processes, they often leave behind materials requiring disposal or regeneration, require costly catalysts or adsorbent materials, or have unacceptable energy costs. For example, the disposal of some solvents (e.g., amine) may cause toxicity to humans and the environment, while the regeneration of adsorbent materials such as zeolites require a substantial amount of energy.

### Dosing Ions in Urban Wastewater Systems

Dosing urban wastewater with specific iron salts (i.e., FeCl₂, FeCl₃, FeSO₄ and Fe₂(SO₄)₂) is a widely accepted and utilised method of chemically conditioning the urban wastewater. In systems known in the art, the specific iron salts mentioned above can be added for various purposes including controlling levels of sulfide and/or phosphate, as well as aiding clarification of the wastewater by promoting coagulation and settling of sludges.

The addition of the specific iron salts discussed above in sewer systems is known in the art to efficiently reduce the corrosion and odour issues caused by the emission of hydrogen sulfide (H₂S). Any dissolved sulfide in the wastewater can be effectively removed by adding ferrous (Fe²⁺) and/or ferric (Fe³⁺) ions to form insoluble ferrous sulfide (FeS). In this process, Fe²⁺ reacts with the dissolved sulfide to form FeS directly. While Fe³⁺ firstly oxidizes the dissolved sulfide to produce elemental sulfur, with the concurrently formed Fe²⁺ afforded by the reduction process reacting with the sulfide to form FeS. In both cases, the FeS formed is substantially insoluble in water. The FeS particles entrained in the water, form either a sediment or agglomerate to form a sludge that is easily removed in the subsequent wastewater treatment processes.

Similar processes known in the art include treating fluids in anaerobic digestors in order to oxidize and precipitate sulfide dissolved in the anaerobic digestor fluids. This substantially prevents sulfide from entering the gas phase, in the form of H₂S, and causing issues such as corrosion to process equipment and obnoxious odours.

Dosing the specific iron salts discussed above at the inlet of a WWTP is a widely used technique to enhance wastewater processes—the practice known in the art as iron salts-based Chemically Enhanced Primary Sedimentation. In this process, phosphates can be partly or substantially removed from wastewater as various insoluble iron-phosphate complexes, removing excessive nutrients from the wastewater, and preventing eutrophication in waters receiving effluent from the process. In addition, the coagulative property of ferric irons (Fe³⁺) can effectively accumulate any organic matter within wastewater, and subsequently separate them from the wastewater as sludge, significantly reducing the organic loading on the downstream biological process.

Further to the above, specific iron salts can also be added to wastewater treatment bioreactors, including aerated bioreactors, to remove phosphate from wastewater, or at least lower the concentration thereof. The reduction in phosphate concentration can enhance the settleability of the sludge entrained in the wastewater after the biological reaction, such that separation of the sludge from treated wastewater in the secondary clarifier can be improved.

One process known in the art comprises in-sewer iron dosing impacting a wastewater treatment plant. In this method the addition of iron salts to sewers resulted in multiple benefits to downstream wastewater treatment and sludge digestion processes, in addition to controlling H₂S in the sewers. The FeS produced in sewers is typically oxidized in wastewater treatment reactors, with the iron ions regenerated subsequently precipitating with phosphate that may be present in the wastewater as insoluble iron-phosphate complexes, resulting in an observable decrease in phosphate concentration. The sludge containing iron-phosphate complexes can subsequently be digested in an anaerobic digester, with iron ions regenerated leading to the precipitation of sulfide dissolved in the digestion fluid, thus reducing the emission of H₂S into the biogas produced therefrom. In addition, dosing of the wastewater with iron salts can improve the aggregation or agglomeration of particles via destabilizing organics and colloidal particles to promote the formation of larger solid particles in the wastewater treatment reactors and in anaerobic digesters, thereby enhancing sludge settleability and dewaterability.

Continuously sourcing and dosing various inputs of reagents and/or ions is both costly and cumbersome, especially for urban wastewater treatment which is generally publicly run under a limited budget. By contrast, generating the reagents and/or ions onsite at the WWTP, or even more preferably, by upgrading the biogas produced from the wastewater treatment process itself, eliminates or at least reduces the need to import said reagents and/or ions from elsewhere. Considering the public utility of wastewater treatment, it is desirable for any additional processes that produce the reagents and/or ions such as biogas upgrading to be: (i) relatively robust, in that it can process wide variations in sludge and wastewater inputs, (ii) self-regulating, and (iii) relatively inexpensive to operate.

While existing methods or processes for dosing ions, in particular iron ions, are able to enhance quality and handleability of treatment products from WWTPs, such as biogas and sludges, these processes require significant and continuous inputs of salts including ammonium, alkaline salts and/or the specific iron salts disclosed above to maintain the concentration of iron ions.

In a process with long residence times such as anaerobic digestion, the requirement for continuously dosing inputs of salts and/or reagents can frequently result in vast continuous amounts of costly material inputs and require close monitoring of reaction conditions such as pH.

Finally, these processes known in the art are significantly limited to removing certain chemicals such as sulfide and phosphate from sludges and biogas. Accordingly, there is a need for a system that can efficiently, inexpensively, and systematically remove the largest non-compressible component gas (i.e., CO₂) from anaerobically produced biogas.

It is an object of the present invention to overcome or ameliorate at least one of the disadvantages of the prior art, or to provide a useful alternative.

### SUMMARY OF THE INVENTION

In a first aspect of the present invention, there is provided a method for removing a portion of at least one contaminant gas from a first gas stream, the method comprising the steps of:
a) applying a voltage across an electrically connected pair of electrodes at least partially in contact with a working fluid in an electrochemical cell to generate a plurality of ions; and
b) reacting at least a portion of the at least one contaminant gas with the plurality of ions in the working fluid to convert the portion of the at least one contaminant gas to one or more reaction products, thereby sequestering at least some of the contaminant gas from the first gas stream to produce a second gas stream,
   wherein the pH of the working fluid is substantially maintained at a predetermined set point for improving the efficiency of the conversion.

It will be appreciated by persons of ordinary skill in the relevant art that for the purposes of the present invention, the second gas stream comprises the first gas stream absent the at least a portion of at least one contaminant gas, and therefore, the second gas stream is enriched in at least one target gas compared to the first gas stream.

For context, the term “target gas” as used herein relates to a gas that is in a substantially purer form than the gas in its raw state as a result of some or all of the contaminant gases having been removed using this method. In general, the target gas is a desirous gas that may have commercial value, wherein said commercial value may be reduced or diminished when the target gas is contaminated by one or more of the contaminant gases.

The method will be described hereinafter in terms of its use in removing at least a portion of one or more contaminant gases from a raw biogas stream. However, it will be appreciated by persons of ordinary skill in the relevant art that this particular method may also find use in a range of commercial applications where a gas stream enriched with a target gas is a desirable outcome. By enriched is meant that the proportion of the target gas in the second gas stream is increased with respect to the proportion of at least one contaminant gas remaining in the second gas stream.

The invention provides many advantages over the prior art. For example, contaminating gases in the raw biogas produced by microbial processes used in wastewater treatment, such as anaerobic digestion, can be at least partially removed from the raw biogas to produce a valuable gas product with commercial application. In particular, the substantial removal of non-compressible contaminants of the biogas, including but not limited to CO₂, improves the usability and value of the biogas. Applying a voltage across an electrically connected pair of electrodes at least partially disposed in a working fluid in an electrochemical cell generates a plurality of ions, which can then be reacted with at least a portion of at least one contaminant in a first gas stream to produce one or more reaction products. The at least one contaminant is sequestered from the first gas stream to produce a second gas stream that is an enriched form of the first gas stream and represents a valuable gas product for commercial application. The at least one contaminant is preferably sequestered in the form of a precipitate in the working fluid, and which is relatively easily separated from the working fluid. In examples of the invention wherein the at least one contaminant in the first gas stream is CO₂ and the plurality of ions comprises iron (Fe) ions, the main precipitate would be FeCO₃. The pH of the working fluid is substantially maintained at a predetermined set point, which improves the efficiency of the reaction which sequesters the at least one contaminant, thereby forming the second gas stream.

In one embodiment, the pH of the working fluid is substantially maintained at a predetermined set point by controlling the voltage and/or the current across the electrically connected pair of electrodes. In another embodiment, the pH of the working fluid is additionally, or alternatively substantially maintained at a predetermined set point by adjusting the flow rate of the first gas stream into the electrochemical cell. It will be appreciated that controlling the voltage and/or the current and/or the flow rate of the first gas stream enables control of the composition of the second gas stream. Preferably, the flow rate of the first gas stream is controlled to maintain the concentration of the at least one contaminant gas to a pre-determined level. In other words, it is possible to “tune” the relative concentrations of the individual components of the second gas stream. Preferably the at least one contaminant gas content is reduced sufficiently such that the second gas stream comprises <5% of the contaminant gas

A significant advantage of the present invention when used in conjunction with wastewater treatment as described above, is the production of iron carbonate (FeCO₃), which can be re-cycled back into the wastewater treatment system. The FeCO₃ produced as a result of the invention can be sourced on-site and recycled back into the sewer network, and/or just prior to primary sedimentation process, and/or the wastewater treatment bioreactor, and/or just prior to the final clarifier, and/or into the anaerobic digestion unit. A further important advance in this field of art is dosing urban wastewater with FeCO₃, irrespective of the source of the FeCO₃. The limited solubility of FeCO₃ particles has limited the use of FeCO₃ in the past. To explain, to the best knowledge of the inventors, only the specific, more soluble iron salts FeCl₂, FeCl₃, FeSO₄ and Fe₂(SO₄)₂ have been utilised to chemically condition urban wastewater.

The use of FeCO₃ is a significant advance in the art, as FeCO₃ has advantages that these other specific iron salts do not possess, namely its ability to maintain and provide additional alkalinity to the wastewater/sludge, as opposed to consuming alkalinity in the wastewater/sludge as do the currently used iron salts. The maintenance of wastewater/sludge alkalinity in this regard maintains and/or enhances conditions favourable for agglomeration and settling materials suspended therein.

The immediate and efficient introduction of electrochemically generated ions in a working fluid according to this particular embodiment of the invention, allows for the in-situ sequestration of the contaminant components from the feed biogas. This eliminates the need to remotely source, transport and introduce the ions by dissolution of reactive salts to electrolytes, providing alternate uses to the product of contaminant gas purification. The combination of gas purification, and by-product use, makes the electrochemical contaminant gas sequestration method of the invention economical and commercially viable.

In various embodiments of the invention, the contaminant gas in the first gas stream is selected from the group consisting of CO₂, H₂S, and ammonia (NH₃), and/or combinations thereof, and the target gas that is enriched in the second gas stream comprises methane (CH₄) and/or hydrogen (H₂).

In one embodiment, the predetermined set point is maintained by adjusting at least one of: the flowrate of the first gas stream; the voltage; and current applied across the electrodes.

In another embodiment, the predetermined set point falls within the range of pH 7.5 to pH 9.0, preferably pH 8.0 to pH 9.0, and even more preferably around pH 8.5. For instance, in some embodiments, the predetermined set point falls within the range of pH 7.5 to pH 7.6, pH 7.6 to pH 7.7, pH 7.7 to pH 7.8, pH 7.8 to pH 7.9, pH 7.9 to pH 8.0, pH 8.0 to pH 8.1, pH 8.1 to pH 8.2, pH 8.2 to pH 8.3, pH 8.3 to pH 8.4, pH 8.4 to pH 8.5, pH 8.5 to pH 8.6, pH 8.6 to pH 8.7, pH 8.7 to pH 8.8, pH 8.8 to pH 8.9, and pH 8.9 to pH 9.0.

In a certain embodiment, the voltage across the electrodes is adjusted between a range of 0.5 V and 50.0 V, preferably between 1.0 V to 10.0 V, and even more preferably between 2.0 V to 5.0 V. For instance, the voltage across the electrodes is adjusted between a range of 0.5 V and 50.0 V, between 0.6 V to 45.0 V, between 0.7 V to 40.0 V, between 0.8 V to 35.0 V, between 0.9 V to 30.0 V, between 1.0 V to 25.0 V, between 1.2 V to 20.0 V, between 1.4 V to 15.0 V, between 1.6 V to 10.0 V, between 1.8 V to 10.0 V, or between 2.0 V to 5.0 V.

In some embodiments, the predetermined set point falls within the range of pH 7.5 to pH 7.6, and the voltage across the electrodes is adjusted between a range of 0.5 V and 50.0 V, between 0.6 V to 45.0 V, between 0.7 V to 40.0 V, between 0.8 V to 35.0 V, between 0.9 V to 30.0 V, between 1.0 V to 25.0 V, between 1.2 V to 20.0 V, between 1.4 V to 15.0 V, between 1.6 V to 10.0 V, between 1.8 V to 10.0 V, or between 2.0 V to 5.0 V. In some embodiments, the predetermined set point falls within the range of pH 7.6 to pH 7.7, and the voltage across the electrodes is adjusted between a range of 0.5 V and 50.0 V, between 0.6 V to 45.0 V, between 0.7 V to 40.0 V, between 0.8 V to 35.0 V, between 0.9 V to 30.0 V, between 1.0 V to 25.0 V, between 1.2 V to 20.0 V, between 1.4 V to 15.0 V, between 1.6 V to 10.0 V, between 1.8 V to 10.0 V, or between 2.0 V to 5.0 V. In some embodiments, the predetermined set point falls within the range of pH 7.7 to pH 7.8, and the voltage across the electrodes is adjusted between a range of 0.5 V and 50.0 V, between 0.6 V to 45.0 V, between 0.7 V to 40.0 V, between 0.8 V to 35.0 V, between 0.9 V to 30.0 V, between 1.0 V to 25.0 V, between 1.2 V to 20.0 V, between 1.4 V to 15.0 V, between 1.6 V to 10.0 V, between 1.8 V to 10.0 V, or between 2.0 V to 5.0 V. pH 7.8 to pH 7.9, and the voltage across the electrodes is adjusted between a range of 0.5 V and 50.0 V, between 0.6 V to 45.0 V, between 0.7 V to 40.0 V, between 0.8 V to 35.0 V, between 0.9 V to 30.0 V, between 1.0 V to 25.0 V, between 1.2 V to 20.0 V, between 1.4 V to 15.0 V, between 1.6 V to 10.0 V, between 1.8 V to 10.0 V, or between 2.0 V to 5.0 V. In some embodiments, the predetermined set point falls within the range of pH 7.9 to pH 8.0, and the voltage across the electrodes is adjusted between a range of 0.5 V and 50.0 V, between 0.6 V to 45.0 V, between 0.7 V to 40.0 V, between 0.8 V to 35.0 V, between 0.9 V to 30.0 V, between 1.0 V to 25.0 V, between 1.2 V to 20.0 V, between 1.4 V to 15.0 V, between 1.6 V to 10.0 V, between 1.8 V to 10.0 V. or between 2.0 V to 5.0 V. In some embodiments, the predetermined set point falls within the range of pH 8.0 to pH 8.1, and the voltage across the electrodes is adjusted between a range of 0.5 V and 50.0 V, between 0.6 V to 45.0 V, between 0.7 V to 40.0 V, between 0.8 V to 35.0 V, between 0.9 V to 30.0 V, between 1.0 V to 25.0 V, between 1.2 V to 20.0 V, between 1.4 V to 15.0 V, between 1.6 V to 10.0 V, between 1.8 V to 10.0 V, or between 2.0 V to 5.0 V. In some embodiments, the predetermined set point falls within the range of pH 8.1 to pH 8.2, and the voltage across the electrodes is adjusted between a range of 0.5 V and 50.0 V, between 0.6 V to 45.0 V, between 0.7 V to 40.0 V, between 0.8 V to 35.0 V, between 0.9 V to 30.0 V, between 1.0 V to 25.0 V, between 1.2 V to 20.0 V, between 1.4 V to 15.0 V, between 1.6 V to 10.0 V, between 1.8 V to 10.0 V, or between 2.0 V to 5.0 V. pH 8.2 to pH 8.3, and the voltage across the electrodes is adjusted between a range of 0.5 V and 50.0 V, between 0.6 V to 45.0 V, between 0.7 V to 40.0 V, between 0.8 V to 35.0 V, between 0.9 V to 30.0 V, between 1.0 V to 25.0 V, between 1.2 V to 20.0 V, between 1.4 V to 15.0 V, between 1.6 V to 10.0 V, between 1.8 V to 10.0 V, or between 2.0 V to 5.0 V. In some embodiments, the predetermined set point falls within the range of pH 8.3 to pH 8.4, and the voltage across the electrodes is adjusted between a range of 0.5 V and 50.0 V, between 0.6 V to 45.0 V, between 0.7 V to 40.0 V, between 0.8 V to 35.0 V, between 0.9 V to 30.0 V, between 1.0 V to 25.0 V, between 1.2 V to 20.0 V, between 1.4 V to 15.0 V, between 1.6 V to 10.0 V, between 1.8 V to 10.0 V, or between 2.0 V to 5.0 V. In some embodiments, the predetermined set point falls within the range of pH 8.4 to pH 8.5, and the voltage across the electrodes is adjusted between a range of 0.5 V and 50.0 V, between 0.6 V to 45.0 V, between 0.7 V to 40.0 V, between 0.8 V to 35.0 V, between 0.9 V to 30.0 V, between 1.0 V to 25.0 V, between 1.2 V to 20.0 V, between 1.4 V to 15.0 V, between 1.6 V to 10.0 V, between 1.8 V to 10.0 V, or between 2.0 V to 5.0 V. pH 8.5 to pH 8.6, and the voltage across the electrodes is adjusted between a range of 0.5 V and 50.0 V, between 0.6 V to 45.0 V, between 0.7 V to 40.0 V, between 0.8 V to 35.0 V, between 0.9 V to 30.0 V, between 1.0 V to 25.0 V, between 1.2 V to 20.0 V, between 1.4 V to 15.0 V, between 1.6 V to 10.0 V, between 1.8 V to 10.0 V, or between 2.0 V to 5.0 V. In some embodiments, the predetermined set point falls within the range of pH 8.6 to pH 8.7, and the voltage across the electrodes is adjusted between a range of 0.5 V and 50.0 V, between 0.6 V to 45.0 V, between 0.7 V to 40.0 V, between 0.8 V to 35.0 V, between 0.9 V to 30.0 V, between 1.0 V to 25.0 V, between 1.2 V to 20.0 V, between 1.4 V to 15.0 V, between 1.6 V to 10.0 V, between 1.8 V to 10.0 V, or between 2.0 V to 5.0 V. In some embodiments, the predetermined set point falls within the range of pH 8.7 to pH 8.8, and the voltage across the electrodes is adjusted between a range of 0.5 V and 50.0 V, between 0.6 V to 45.0 V, between 0.7 V to 40.0 V, between 0.8 V to 35.0 V, between 0.9 V to 30.0 V, between 1.0 V to 25.0 V, between 1.2 V to 20.0 V, between 1.4 V to 15.0 V, between 1.6 V to 10.0 V, between 1.8 V to 10.0 V, or between 2.0 V to 5.0 V. In some embodiments, the predetermined set point falls within the range of pH 8.8 to pH 8.9, and the voltage across the electrodes is adjusted between a range of 0.5 V and 50.0 V, between 0.6 V to 45.0 V, between 0.7 V to 40.0 V, between 0.8 V to 35.0 V, between 0.9 V to 30.0 V, between 1.0 V to 25.0 V, between 1.2 V to 20.0 V, between 1.4 V to 15.0 V, between 1.6 V to 10.0 V, between 1.8 V to 10.0 V, or between 2.0 V to 5.0 V. In some embodiments, the predetermined set point falls within the range of pH 8.9 to pH 9.0, and the voltage across the electrodes is adjusted between a range of 0.5 V and 50.0 V, between 0.6 V to 45.0 V, between 0.7 V to 40.0 V, between 0.8 V to 35.0 V, between 0.9 V to 30.0 V, between 1.0 V to 25.0 V, between 1.2 V to 20.0 V, between 1.4 V to 15.0 V, between 1.6 V to 10.0 V, between 1.8 V to 10.0 V, or between 2.0 V to 5.0 V.

Preferably the voltage is kept relatively low to save energy consumption. However, in certain cases, it may be preferable to utilise a higher voltage to save on material costs (by, for example, using recycled iron) or reducing the capital costs, at the expense of energy costs.

In one embodiment, at least one of the electrodes comprises a metal selected from the group consisting of iron (Fe), magnesium (Mg), zinc (Zn), nickel (Ni), copper (Cu), Aluminium (AI), titanium (Ti), or an alloy thereof. The plurality of ions electrochemically generated from these metal electrodes in the electrochemical cell are reactive towards the at least one contaminant gas.

In embodiments of the invention, at least one of the electrodes comprises a metal selected from the group consisting of iron (Fe), magnesium (Mg), zinc (Zn), nickel (Ni), copper (Cu), aluminium (AI), and titanium (Ti), wherein said selected electrode generates a plurality of corresponding ions selected from the group consisting of iron (Fe) ions, magnesium (Mg) ions, zinc (Zn) ions, nickel (Ni) ions, copper (Cu) ions, aluminium (Al) ions, and titanium (Ti) ions.

Accordingly, in embodiments of the invention where the first gas stream comprises a contaminant gas that is carbon dioxide (CO₂), one or more of the reaction products produced by the method of the invention may be selected from the group consisting of magnesium carbonate (MgCO₃), iron (II) carbonate (FeCO₃), zinc carbonate (ZnCO₃), nickel (II) carbonate (NiCO₃), copper (II) carbonate (CuCO₃), aluminium carbonate Al₂(CO₃)₃, and titanium (III) carbonate Ti₂(CO₃)₃, being dependent on the metal electrodes selected.

In an embodiment, at least one of the electrodes comprises iron (Fe) and the at least one contaminant gas is carbon dioxide (CO₂), wherein the one or more reaction products formed comprises a slurry of iron (II) carbonate (FeCO₃), which is separated from the working fluid.

Preferably, the second gas stream has less than 30, 20, 10, 5 or 1 wt. % CO₂. For instance, in some embodiments, the second gas stream has less than 30, 29, 28, 27, 26, 25, 24, 23, 22, 21, 20, 19, 18, 17, 16, 15, 14, 13, 12, 11, 9, 8, 7, 6, 5, 4, 3, 2 or 1 wt. % CO₂. In one embodiment, at least one of the electrodes comprises iron (Fe) and the at least one contaminant gas is hydrogen sulfide (H₂S), wherein the one or more reaction products formed comprises iron (II) sulfide (FeS), which is separated from the working fluid.

In other embodiments, at least one of the electrodes comprises magnesium (Mg) and the at least one contaminant gas is hydrogen sulfide (H₂S), wherein the one or more reaction products formed comprises magnesium sulfide (MgS), which is separated from the working fluid.

In other embodiments, at least one of the electrodes comprises zinc (Zn) and the at least one contaminant gas is hydrogen sulfide (HS), wherein the one or more reaction products formed comprises zinc sulfide (ZnS), which is separated from the working fluid.

In other embodiments, at least one of the electrodes comprises copper (Cu) and the at least one contaminant gas is hydrogen sulfide (H₂S), wherein the one or more reaction products formed comprises copper (I) sulphide (Cu₂S), which is separated from the working fluid.

In other embodiments, at least one of the electrodes comprises nickel (Ni) and the at least one contaminant gas is hydrogen sulfide (H₂S), wherein the one or more reaction products formed comprises nickel sulfide (NiS), which is separated from the working fluid.

In other embodiments, at least one of the electrodes comprises aluminium (Al) and the at least one contaminant gas is hydrogen sulfide (H₂S), wherein the one or more reaction products formed comprises aluminium sulfide (Al₂S₃), which is separated from the working fluid.

In other embodiments, at least one of the electrodes comprises titanium (Ti) and the at least one contaminant gas is hydrogen sulfide (H₂S), wherein the one or more reaction products formed comprises titanium sulfide (TiS), which is separated from the working fluid.

Preferably, the second gas stream has less than 1000, 500, 300, 200, 100, or 10 ppmv H₂S. For instance, in some embodiments, the second gas stream has less than 950, 900, 850, 800, 750, 700, 650, 600, 550, 500, 450, 400, 350, 300, 250, 200, 150, 100, 95, 90, 85, 80, 75, 70, 65, 60, 55, 50, 45, 40, 35, 30, 25, 20 or 10 ppmv H₂S.

In a certain embodiment, the at least one contaminant gas is ammonia (NH₃), and wherein the one or more reaction products formed comprises aqueous ammonium (NH₄⁺), at least some of which is removed from the working fluid by purging at least a portion thereof from the electrochemical cell. Preferably, the second gas stream has less than 1000, 100, 10, or 1 ppmv NH₃. For instance, in some embodiments, the second gas stream has less than 950, 900, 850, 800, 750, 700, 650, 600, 550, 500, 450, 400, 350, 300, 250, 200, 150, 100, 95, 90, 85, 80, 75, 70, 65, 60, 55, 50, 45, 40, 35, 30, 25, 20, 15, 10, 5, 4, 3, 2 or 1 ppmv NH₃.

In an embodiment, at least a portion of the second gas stream is recycled back into the first gas stream.

In one embodiment, the first gas stream comprises at least one contaminant gas selected from the group consisting of CO₂, H₂S, NH₃, NOx and a halogen. For instance, the halogen typically comprises chlorine (CI), gas but may also comprise fluorine (F) gas.

In another embodiment, the first gas stream is biogas, and wherein the biogas is generated during anaerobic digestion of organic matter. The organic matter can be derived from the group consisting of sewage/wastewater, agricultural wastes, municipal wastes, manure, plant materials, green wastes, and food wastes. Alternatively, the organic matter is a sludge derived from sewage or wastewater.

In a further embodiment, the working fluid comprises an electrolyte solution of an alkali metal or alkaline earth metal salt. Preferably, the alkali metal or alkaline earth metal salt is selected from the group of alkali metal or alkaline earth metals consisting of sodium (Na), potassium (K), lithium (Li), magnesium (Mg), calcium (Ca), or a mixture thereof.

In one embodiment, the electrolyte is an aqueous NaCl solution, preferably the concentration of the NaCl solution is between about 0.1% to about 5%, preferably in the range of about 0.5% to about 3%, and even more preferably in the range of about 1% to about 2%. For instance, in some embodiments, the concentration of the NaCl solution is between about 0.1% to about 5%, about 0.2% to about 4.5%, about 0.3% to about 4%, about 0.4% to about 3.5%, about 0.5% to about 3%, about 0.6% to about 2.5%, about 0.7% to about 2.3%, about 0.8% to about 2.2%, about 0.9% to about 2.1%, or about 1% to about 2%.

Preferably the electrodes are formed from iron or are at least partially formed from iron. The iron used could be manufactured iron (from iron ore or recycled iron) or recycled iron scraps.

In a certain embodiment, the method further comprises prior to step a) or prior to step b), the step of:
a1) fluidly communicating at least a portion of the first gas stream having the at least one contaminant gas from a gas source to the electrochemical cell.
   In one embodiment, a gas scrubbing process may be utilised, or alternatively a bubbling column method may be employed, as discussed further below.

In another embodiment, step b) comprises fluidly communicating at least a portion of the first gas stream having the at least one contaminant gas, with at least a portion of the working fluid in a gas-liquid reactor in circulating fluid communication with the electrochemical cell, wherein the plurality of electrochemically generated ions from the electrochemical cell and the at least one contaminant gas are brought into fluidic contact in the gas-liquid reactor. Preferably, the gas-liquid reactor is selected from a gas scrubber and a bubbling column. Furthermore, the plurality of electrochemically generated ions and at least a portion of the first gas stream are preferably brought into fluidic contact in a counter-current arrangement. Preferably the first gas stream is compressed to flow through the gas-liquid reactor.

In a certain embodiment, the method further comprises the step of thickening/dewatering the one or more reaction products.

In a second aspect of the present invention, there is provided a second gas stream produced by the method described hereabove, wherein the second gas stream has a lower concentration of the at least one contaminant gas than the first gas stream. In this embodiment, the second gas stream is enriched with hydrogen (H₂), the molar increase in hydrogen being proportional to the molar reduction in the at least one contaminant gas.

In another embodiment, the quantity of H₂ produced (in moles) is roughly equivalent to the quantity of CO₂ and H₂S removed (both in moles). This means that the second gas contains high concentrations of H₂.

In a third aspect of the present invention, there is also provided a use of the second gas stream described hereabove, including as a transport fuel, as a fuel for injecting into a natural gas network to supplement a supply of natural gas, for further purification and/or separating the component gases thereof.

In a fourth aspect of the present invention, there is provided a system for removing a portion of at least one contaminant gas from a first gas stream, the system comprising:
an electrochemical cell comprising an electrically connected pair of electrodes at least partially disposed within a working fluid, wherein, when a voltage is applied across the electrodes, a plurality of ions is electrochemically generated in the working fluid for reacting with at least a portion of the at least one contaminant gas to convert the portion of the at least one contaminant gas to one or more reaction products, thereby sequestering at least some of the contaminant gas from the first gas stream thereby to produce a second gas stream,
   wherein the pH of the working fluid is substantially maintained at a predetermined set point for improving the efficiency of the conversion.

In one embodiment, the predetermined set point is maintained by adjusting at least one of: the flowrate of the first gas stream; the voltage; and current applied across the electrodes.

In another embodiment, the predetermined set point falls within the range of pH 7.5 to pH 9.0, preferably pH 8.0 to pH 9.0, and even more preferably around pH 8.5. For instance, in some embodiments, the predetermined set point falls within the range of pH 7.5 to pH 7.6, pH 7.6 to pH 7.7, pH 7.7 to pH 7.8, pH 7.8 to pH 7.9, pH 7.9 to pH 8.0, pH 8.0 to pH 8.1, pH 8.1 to pH 8.2, pH 8.2 to pH 8.3, pH 8.3 to pH 8.4, pH 8.4 to pH 8.5, pH 8.5 to pH 8.6, pH 8.6 to pH 8.7, pH 8.7 to pH 8.8, pH 8.8 to pH 8.9, and pH 8.9 to pH 9.0.

In a further embodiment, the voltage across the electrodes is adjusted between a range of 0.5 V and 50.0 V, preferably between 1.0 V to 10.0 V, and even more preferably between 2.0 V to 5.0V. For instance, the voltage across the electrodes is adjusted between a range of 0.5 V and 50.0 V, between 0.6 V to 45.0 V, between 0.7 V to 40.0 V, between 0.8 V to 35.0 V, between 0.9 V to 30.0 V, between 1.0 V to 25.0 V, between 1.2 V to 20.0 V, between 1.4 V to 15.0 V, between 1.6 V to 10.0 V, between 1.8 V to 10.0 V, or between 2.0 V to 5.0 V.

In an embodiment, at least one of the electrodes comprises iron (Fe), and the at least one contaminant gas is carbon dioxide (CO₂), wherein the one or more reaction products formed comprises a slurry of iron (II) carbonate (FeCO₃), which is separated from the working fluid. Preferably, the second gas stream has less than 30, 20, 10, 5 or 1 wt. % CO₂. For instance, in some embodiments, the second gas stream has less than 30, 29, 28, 27, 26, 25, 24, 23, 22, 21, 20, 19, 18, 17, 16, 15, 14, 13, 12, 11, 9, 8, 7, 6, 5, 4, 3, 2 or 1 wt. % CO₂.

In a certain embodiment, at least one of the electrodes comprises iron (Fe) and the at least one contaminant gas is hydrogen sulfide (H₂S), wherein the one or more reaction products formed comprises a slurry of iron (II) sulfide (FeS), which is separated from the working fluid. Preferably, the second gas stream has less than 1000, 500, 300, 200, 100, or 10 ppmv H₂S. For instance, in some embodiments, the second gas stream has less than 950, 900, 850, 800, 750, 700, 650, 600, 550, 500, 450, 400, 350, 300, 250, 200, 150, 100, 95, 90, 85, 80, 75, 70, 65, 60, 55, 50, 45, 40, 35, 30, 25, 20 or 10 ppmv H₂S.

In one embodiment, the at least one contaminant gas is ammonia (NH₃), and wherein the one or more reaction products formed comprises aqueous ammonium (NH⁴⁺). Preferably, the second gas stream has less than 1000, 100, 10 or 1 ppmv NH₃. For instance, in some embodiments, the second gas stream has less than 950, 900, 850, 800, 750, 700, 650, 600, 550, 500, 450, 400, 350, 300, 250, 200, 150, 100, 95, 90, 85, 80, 75, 70, 65, 60, 55, 50, 45, 40, 35, 30, 25, 20, 15, 10, 5, 4, 3, 2 or 1 ppmv NH₃.

In another embodiment, at least a portion of the second gas stream is recycled back into the first gas stream.

In a further embodiment, the first gas stream comprises at least one contaminant gas selected from the group consisting of CO₂, H₂S, NH₃, NOx and a halogen. For instance, the halogen typically comprises chlorine (CI), gas but may also comprise fluorine (F) gas.

In a certain embodiment, the first gas stream is biogas, and wherein the biogas is generated during anaerobic digestion of organic matter. Preferably, the organic matter is derived from the group consisting of sewage/wastewater, agricultural wastes, municipal wastes, manure, plant materials, green wastes, and food wastes. Alternatively, the organic matter is a sludge derived from sewage or wastewater.

In an embodiment, the working fluid comprises an electrolyte. Preferably, the electrolyte is an aqueous NaCl solution, preferably the concentration of the NaCl solution is between about 0.1% to about 5%, preferably in the range of about 0.5% to about 3%, and even more preferably in the range of about 1% to about 2%. For instance, in some embodiments, the concentration of the NaCl solution is between about 0.1% to about 5%, about 0.2% to about 4.5%, about 0.3% to about 4%, about 0.4% to about 3.5%, about 0.5% to about 3%, about 0.6% to about 2.5%, about 0.7% to about 2.3%, about 0.8% to about 2.2%, about 0.9% to about 2.1%, or about 1% to about 2%. In another embodiment, the system further comprises a gas-liquid reactor in circulating fluid communication with the electrochemical cell, for fluidly receiving working fluid including the plurality of electrochemically generated ions, and the first gas stream, wherein the gas-liquid reactor is adapted to bring into fluidic contact the plurality of electrochemically generated ions from the electrochemical cell and the at least one contaminant gas. The gas-liquid reactor is preferably selected from a gas scrubber and a bubbling column. Preferably, the gas-liquid reactor brings the plurality of electrochemically generated ions and at least a portion of the first gas stream into fluidic contact in a counter-current arrangement.

In a further embodiment, the system further comprises a compressor for compressing the first gas stream.

In a certain embodiment, the system further comprises a purge stream for removing at least a portion of the working fluid. The purge stream is preferably adapted to remove at least some of the aqueous ammonium (NH₄⁺) from the working fluid.

In one embodiment, the system further comprises a solid-liquid separation device for thickening/dewatering the one or more reaction products.

In a fifth aspect of the present invention, there is provided a process for treating sewage or wastewater, comprising the steps of:
obtaining sewage, wastewater and/or a sludge derived therefrom;
fluidly communicating at least a portion of the sewage, wastewater and/or sludge derived therefrom to an anaerobic digester to generate a first gas stream comprising at least one contaminant gas;
fluidly communicating at least a portion of the first gas stream to the system described hereabove to convert at least a portion of the at least one contaminant gas to one or more reaction products; and
adding at least a portion of the one or more reaction products to one or more of:
   (a) the sewage and/or wastewater,
   (b) the sludge derived from the sewage and/or wastewater, or
   (c) the anaerobic digester,
to:
   (i) react with one or more contaminants therein to facilitate at least the partial removal of the contaminant(s) therefrom; and/or
   (ii) enhance the settling and/or dewatering performance of the sludge.

The invention provides many advantages over the prior art, for example by integrating the ion generation function with the sequestering and removal of the contaminant gas component of the biogas.

By utilising electrochemical generation, a readily available and continuous source of reaction product(s) can be sourced for forming a sludge used in the wastewater treatment process. This enhances both the process efficiency of settling and water clarification, as well as providing synergy with the electrochemical biogas purification method, which generates the reaction product(s) which are subsequently used in a wastewater treatment process.

In one embodiment, at least one of the electrodes comprises iron (Fe), and the at least one contaminant gas is carbon dioxide (CO₂), wherein the one or more reaction products formed comprises a slurry of iron (II) carbonate (FeCO₃). The sewage and/or wastewater is preferably sourced from a sewer network, and at least one contaminant identified in the sewer network is a sulfide. Similarly, at least one of the one or more contaminants identified in the anaerobic digester is a sulfide.

In another embodiment, the FeCO₃ slurry reacts with the sulfide to produce iron (II) sulfide (FeS). Advantageously, removing dissolved sulfide from sewage/wastewater to eliminate/reduce the emission of H₂S from sewage/wastewater to sewer atmosphere reduces sewer corrosion and odour emissions, or digester which leads to the reduction of H₂S in biogas.

In a further embodiment, the wastewater or sludge is sourced from an inlet of a wastewater treatment plant (WWTP) or from a bioreactor of the WWTP, and at least one of the one or more contaminants at least partially removed therefrom is a phosphate. The FeCO₃ slurry preferably reacts with the phosphate to produce one or more insoluble iron-phosphate complexes.

In a certain embodiment, the settling and/or dewatering performance of the sludge in the wastewater treatment bioreactor and/or anaerobic digester is enhanced by FeCO₃ induced coagulation of the sludge.

In a sixth aspect of the present invention, there is also provided a process for treating sewage or wastewater, comprising the step of:

treating sewage, wastewater, and/or a sludge derived therefrom, with iron (II) carbonate (FeCO₃) to:
(i) react with one or more contaminants therein to facilitate at least the partial removal of the contaminant(s) therefrom; and/or
(ii) enhance the settling and/or dewatering performance of the sludge.

In one embodiment, the sewage and/or wastewater is sourced from a sewer network, and at least one of the one or more contaminants partially removed therefrom is a sulfide or a phosphate. The wastewater is preferably sourced from landfill, and at least one of the one or more contaminants at least partially removed therefrom is a sulfide. Alternatively, the sludge is sourced from an anaerobic digester, and at least one or the one or more contaminants at least partially removed therefrom is a sulfide. Preferably, the FeCO₃ reacts with the sulfide to produce iron (II) sulfide (FeS).

In an alternative embodiment, the wastewater or sludge is sourced from an inlet of a wastewater treatment plant (WWTP) or from a bioreactor of the WWTP, and at least one of the one or more contaminants at least partially removed therefrom is a phosphate. Preferably, the FeCO₃ reacts with the phosphate to produce one or more insoluble iron-phosphate complexes.

In an alternatively preferable embodiment, the sludge is sourced from an anaerobic digester or a WWTP bioreactor, and the settling and/or dewatering performance of the sludge is enhanced by FeCO₃ induced coagulation of the sludge.

### Definitions

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising”. “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

The examples are not intended to limit the scope of the invention. In what follows, or where otherwise indicated, “%” will mean “volume %”, “ratio” will mean “volume ratio” and “parts” will mean “volume parts”.

The term “substantially” as used herein shall mean comprising more than 50% by volume, mass, or weight, according to the context is it used, unless otherwise indicated. Preferably, it is meant to mean more than 75%. Even more preferably, it is meant to mean more than 90%. Most preferably, it is meant to mean 100% or close to 100%.

The recitation of a numerical range using endpoints includes all numbers subsumed within that range (e.g., 1 to 5 includes 1, 1.5, 2, 2.75, 3, 3.80, 4, 5 etc.).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

It must also be noted that, as used in the specification and the appended claims, the singular forms “a”, “an” and “the” include plural referents unless the context clearly dictates otherwise.

As used herein, the phrase “contaminant gas” relates to gas(es) considered as impurities or undesirable or unwanted components that are present in a first gas stream (i.e., natural gas and/or biogas streams), which could be as a result of anaerobic digestion of organic matter. Preferably, the contaminant gas is at least partially soluble in a working fluid, and preferably reacts with free metal ions in the working fluid to form a species that is at least partially insoluble in the working fluid.

As used herein, the phrase “first gas stream” relates to a gas stream that can be a natural gas stream, an industrial gas stream, or more preferably, a biogas stream produced as a result of anaerobic digestion of organic matter, in which said gas stream is a gas mixture comprising one or more contaminant gas(es) that once when at least partially removed, yields a second gas stream that is suitably enriched for commercial application.

As used herein, the phrase “second gas stream” relates to a gas stream that has been enriched following at least partial removal of one or more contaminant gas(es) from a first gas stream.

As used herein, the phrase “working fluid” relates to a liquid medium comprising an electrolyte for use in an electrochemical cell.

The prior art referred to herein is fully incorporated herein by reference. Although exemplary embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

### BRIEF DESCRIPTION OF THE DRAWINGS

The invention will now be described, by way of example with reference to the accompanying drawings, in which:

FIG. 1 is a process flow schematic of an exemplary embodiment of the present invention utilising a single-stage reaction vessel;

FIG. 2a is a process flow schematic of a preferred embodiment of the present invention, comprising a two-stage reaction scheme across an electrochemical cell and a bubbling column. FIG. 2b shows a similar two-stage reaction scheme with a scrubbing column replacing the bubbling column of FIG. 2a;

FIG. 3 is a simplified process flow diagram of one embodiment of the present invention wherein a gas feed including a contaminant gas and N₂ as a proxy for CH₄ was electrochemically treated to produce an enriched gas stream;

FIG. 4 is a graphical representation of test results obtained from electrochemically purifying a feed gas including N₂ and CO₂ at pH 7.5;

FIG. 5 is a graphical representation of test results obtained from electrochemically purifying a feed gas including N₂ and CO₂ at pH 8.0;

FIG. 6 is a graphical representation of test results obtained from electrochemically purifying a feed gas including N₂ and CO₂ at pH 8.5;

FIG. 7 is a graphical representation of test results obtained from electrochemically purifying a feed gas including N₂ and CO₂ at pH 9.0;

FIG. 8 is a graphical representation of test results obtained from electrochemically purifying a feed gas including N₂ and CO₂ at various pH levels;

FIGS. 9a to 9f are a graphical representation of test results obtained from electrochemically purifying a feed gas similar to raw biogas at pH 8.5. FIGS. 9g to 9i are a graphical comparison of results obtained from electrochemically purifying feed gases predominantly comprising CH₄ and N₂, showing N₂ can be used as a proxy for CH₄;

FIG. 10 is a graphical representation of test results obtained from electrochemically purifying a feed gas including N₂ and CO₂ at various feed gas flow levels;

FIG. 11 is a graphical representation of the XRD crystallography profile of the FeCO₃ particles electrochemically produced from purifying a feed gas at pH 8.5;

FIG. 12 is a graphical representation of particle size distribution and settleability of various FeCO₃ particles electrochemically produced at pH 8.5 and stored for varying amounts of time;

FIGS. 13a to 13d are a graphical representation of the effects to sulfide concentrations in wastewater when FeCO₃ slurries of varying age are dosed in varying concentrations. FIGS. 13e and 13f are graphical representations of the effects on wastewater pH when FeCO₃ slurries of varying age are under- and over-dosed, respectively;

FIG. 14 is a graphical representation of the effects on wastewater pH from dosing a FeCO₃ slurry to wastewater containing sulfide in a sewer-like condition;

FIG. 15 is a graphical representation of the effects from dosing a FeCO₃ slurry to aerated sludge containing phosphate in a simulated biological wastewater treatment condition;

FIG. 16 is a graphical representation of the effects from dosing a FeCO₃ slurry to sludge containing sulfide in a simulated anaerobic digestor;

FIGS. 17a and 17b are graphical representations of the effects from dosing a FeCO₃ slurry to sewer-like conditions and the flow-on effect on aerated biological treatment, respectively, in a simulated wastewater treatment plant;

FIGS. 18a and 18b are a graphical comparison of the conversions of nitrogenous compounds in an aerated sludge receiving wastewater without FeCO₃ dosing (FIG. 18a) and with FeCO₃ dosing (FIG. 8b);

FIG. 19 is a graphical representation of the flow-on effects to a simulated anaerobic digestor from dosing a FeCO₃ slurry in a simulated sewer;

FIG. 20a is a graphical comparison of the settleability, measured as the sludge volume index (SVI), of the wastewater sludge with and without FeCO₃ dosing, and FIG. 20b is a graphical comparison of the dewaterability, measured as the suction resistance force (SRF), of the anaerobically digested sludge, with and without FeCO₃;

FIG. 21 is a graphical representation of the effects to a simulated anaerobic digestor from dosing a FeCO₃ slurry directly thereto;

FIG. 22 is a process flow diagram of one embodiment of the present invention showing a wastewater treatment plant including a cell for purifying raw biogas from an anerobic digestor and dosing FeCO₃ slurry produced therefrom in the sewer network leading to said plant; and

FIG. 23 is a process flow diagram of another embodiment of the wastewater treatment plant wherein the FeCO₃ electrochemically produced from purifying anaerobically digested biogas is directly dosed throughout several unit operations of the plant.

### DETAILED DESCRIPTION OF THE INVENTION

The skilled addressee will understand that the invention comprises the embodiments and features disclosed herein as well as all combinations and/or permutations of the disclosed embodiments and features.

### Example 1—Single-Stage Purification

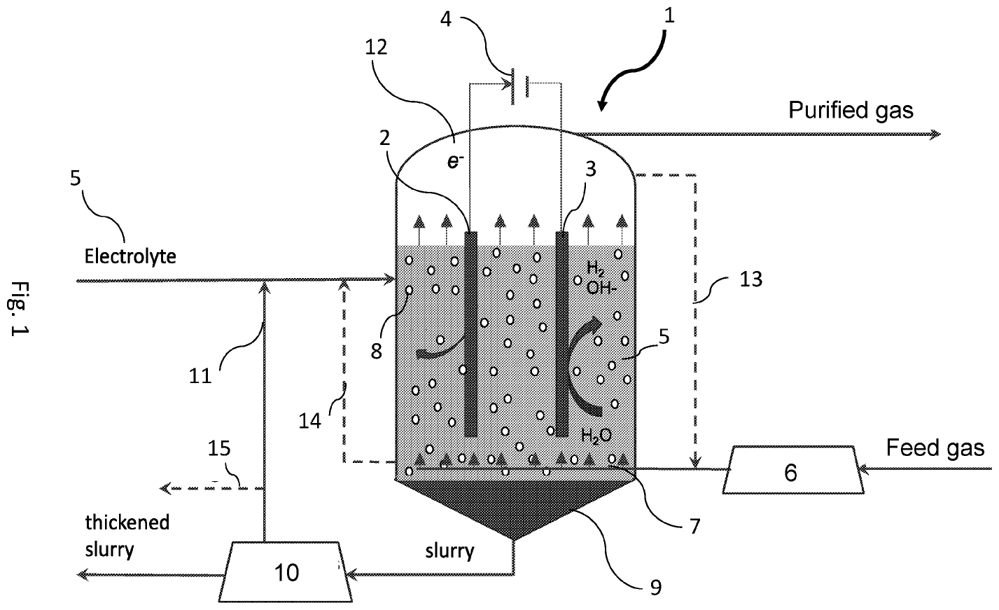

Referring initially to one exemplary embodiment of the invention shown in FIG. 1, there is provided a system for purifying a gas stream comprising biogas from an anaerobic digestor, by removing at least one contaminant gas, CO₂, H₂S and NH₃, by precipitating/ionising said contaminant gas with electrochemically produced iron (Fe) ions.

The electrochemical cell 1 produces an electrical potential between the anode 2 and the cathode 3 using an electrical supply 4. The cell 1 produces Fe²⁺ ions at the anode 2 by sacrificially oxidising the iron-comprising anode, and H₂ and OH− at the cathode 3 by splitting water comprising the electrolyte 5. Biogas is compressed by a compressor 6 and introduced into the cell bubblers 7 to forming fine, or micro- or nano-scale bubbles 8. The up-travelling gas bubbles 8 contact with the electrolyte 5 containing Fe²⁺ and OH⁻, where contaminant gases, predominated by CO₂, in the gas bubbles diffuse into the electrolyte 5, forming ions including bicarbonate, carbonate, sulfide and ammonium in alkali pH conditions.

The dissolved ions in the electrolyte 5 precipitate with Fe²⁺ to form insoluble iron salts including FeCO₃, which settle to the raked base 9 of the cell 1 in the form of a slurry and is subsequently removed from the base 9. The slurry is thickened in a liquid-solids separator 10, with the thickened slurry transported for dosing operations on-site or stored in a suitable vessel for further use. The electrolyte 5 that is removed from the slurry in the liquid-solids separator is recirculated back into the electrolyte replenishment feed 11 for the cell 1.

The remaining CH₄, now substantially comprising the biogas bubbles 6, has a low solubility in the electrolyte 5, and thus remains entrained in the bubbles traveling upwardly to enter the headspace 12 of the cell 1 along with the H₂ gas formed at the cathode 3. The substantially enriched biogas top-product is removed from the headspace 8 to be pumped through or stored in suitable vessels.

In optional embodiments where the enriched biogas in headspace 12 still contains CO₂ above the desired level, at least a portion of the enriched biogas is recirculated back to the gas bubbler 7 in a gas recycle stream 13 for further purification. The electrolyte 5 of the cell 1 can be similarly recirculated in an optional embodiment comprising an electrolyte recycling stream 14.

In this optional embodiment, both recycling streams join with their respective biogas and electrolyte feed streams to moderate the incoming concentrations of each feed and improve efficiency of the unit's steady state operations. Both or either of the streams can be opened or closed in this optional embodiment, their operations responsive to manual user intervention or via electronic control inputs from a controller such as a PID controller.

In another optional embodiment, the cell 1 includes an electrolyte purge stream 15 to purge a portion of the recirculating electrolyte separated from the slurry in the liquid-solid separator 10. The purge stream 15 is substantially adapted to remove at least a portion of the electrolyte containing non-sedimentary precipitates and/or soluble matters of other gas contaminants from the biogas feed stream, including sulfide such as FeS and ammonium salts formed in the cell 1. These precipitates tend to be smaller and less sedimentary, resulting in difficulties removing them from the electrolyte 5. When opened by manual inputs or electronic controller inputs, the purge stream removes at least a portion of the electrolyte 5, with it removing dissolved salts and the smaller non-sedimentary precipitates from further circulation in the system.

### Example 2—Two Stage Purification

In certain embodiments of the present invention, there is provided a two-stage process for: 1) electrochemically producing ions; and 2) purifying the contaminated gas feed using said ions. These two stages are performed in separate reaction vessels using a variety of methods to contact the gas feed and the dissolved electrochemically produced ions. The contacting methods include, but are not limited to, gas bubbling and/or mist-based gas scrubbing.

### Example 2.1

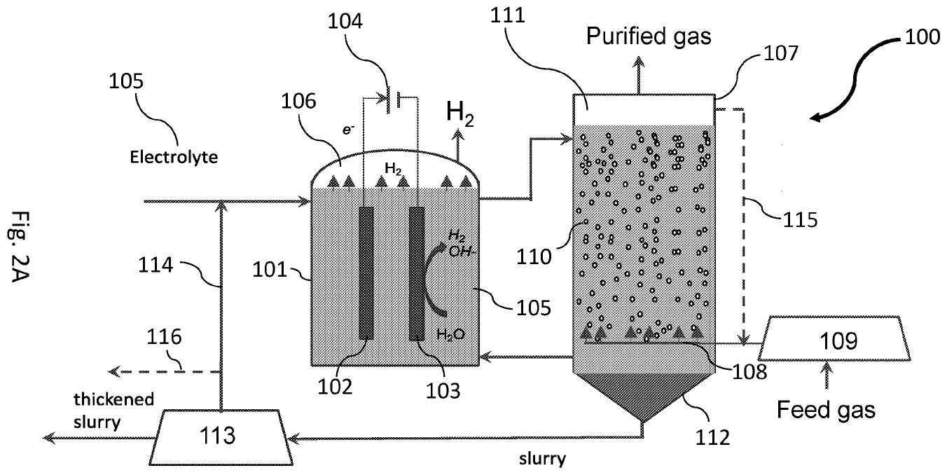

Referring to FIG. 2A, the system 100 comprises an electrochemical cell 101 comprising a sacrificial iron-containing anode 102 and a cathode 103 in electrical communication with an electrical supply 104 providing an electrical potential to the electrolyte 105. The cell 101 produces metallic ions such as Fe²⁺ at the sacrificial anode 102, while the electrolyte is reduced at the cathode 103 to form H₂ gas and OH⁻ ions. The electrochemically produced ions remain in the electrolyte 105, while the H₂ gas bubbles through the electrolyte to the headspace 106 of the cell 101 to be subsequently pumped out of the cell for storage or to be reused.

In this embodiment, the cell 101 is in fluid communication with a bubbling column 107 filled with electrolyte 105 and comprising a bubbler 108 located at the bottom of said column, adapted to deliver a feed of contaminated biogas, compressed by a compressor 109, in the form of fine, or micro- or nano-scale bubbles 110 into said electrolyte 105.

The biogas bubbles 110 produced by the bubbler 108 is brought into contact with the electrolyte 105 containing metallic ions and OH⁻, where CO₂ and other contaminant gases comprising thereof diffuse into the electrolyte 105, forming ions including carbonate and bicarbonate, sulfide, and ammonium ions in alkali pH conditions. The biogas bubbles 110, now substantially stripped of contaminant gases bubble to the column headspace 111 of the bubbling column 107, from which the enriched biogas (labelled in FIG. 2A as “purified gas”) top product is pumped out for immediate use elsewhere or stored in a vessel for future use.

The electrolyte 105 comprising metallic ions produced in the cell 101 by sacrificially oxidising the iron-comprising anode 102 is pumped into the bubbling column 107, where the dissolved contaminant gas ions, in particular the carbonates, in the electrolyte 105 precipitate with the metallic ions to form metallic carbonate precipitates, which settle to the raked base 112 of the bubbling column 107 in the form of a slurry. In a similar manner to Example 1, this slurry is subsequently removed from the base 112 for thickening in a liquid-solids separator 113, with the thickened slurry transported for dosing operations on-site or stored in a suitable vessel for further use. The electrolyte 106 that is removed from the slurry in the liquid-solids separator 113 is recirculated back into the electrolyte replenishment feed 114 for the cell 101. Similarly, electrolyte 105 that not comprising the slurry formed at the raked base 112 is also recirculated back into the cell 101 for further electrolysis.

Similar to the single-tank embodiment of Example 1, optional embodiments of the system 100 illustrated in FIG. 2A can also comprise a variety of recycling streams, as well as purge streams to remove non-sedimenting reaction products. In this regard, optional embodiments can include a gas recycling stream 115 where the enriched biogas in the column headspace 111 still contains CO₂ above the desired level in order to enable at least a portion of the enriched biogas to be recirculated back to the gas bubbler 108. As per the single cell-only embodiment of Example 1, the various recirculating streams of this embodiment are controlled to optimise the reaction efficiency during steady state operation and manage the material balance across the system 100.

In another optional embodiment, the system 100 includes an electrolyte purge stream 116 to purge a portion of the recirculating electrolyte separated from the slurry in the liquid-solid separator 113. Similar to that of Example 1, the purge stream 116 is substantially adapted to remove at least a portion of the electrolyte 105 containing non-sedimentary materials of other gas contaminants from the biogas feed stream, including sulfide such as FeS and ammonium salts formed in the bubbling column 107.

### Example 2.2

Referring to FIG. 2B, there is another embodiment of the gas purification system provided, wherein the gas-liquid contacting is made in a spraying scrubber.

In this embodiment, the system 100a comprises a scrubbing column 107a replacing the bubbling column 107 of system 100, wherein the compressed biogas feed passes through a gas dispersion outlet 108a to disperse uniformly across the scrubbing column 107a. The electrolyte 105a in the electrochemical cell 101a, containing metallic ions such as Fe²⁺ and OH⁻, is pumped to the top of the scrubbing column 107a where it enters the column through a spray nozzle 117a, forming droplets.

The up-travelling biogas and the down-travelling liquid droplets of electrolyte 105a achieve counter-current contact, through which contaminant gases such as CO₂ is absorbed into the droplets, converted to ions such as bicarbonate and carbonate in the presence of OH⁻ ions therein. In this case, insoluble precipitates of FeCO₃ from the carbonate and Fe₂′ within the droplets and collect at the raked base of the scrubbing column 107a. In particular, the metallic carbonate particles such as FeCO₃ precipitates settle to form a slurry, which is subsequently removed as bottoms product while the supernatant of the slurry is recycled to the electrochemical cell 101a to replenish the electrolyte 105a.

The CH₄ comprising the biogas feed has a low solubility in the droplets, and thus travels to the top of the scrubbing column 107a for collection. The headspace 111a may still contain some CO₂.

As per the embodiment illustrated in Example 2.1, optional embodiments of the system 100a illustrated in FIG. 2B can also comprise a gas recycling stream 115a, as well as a purge stream 116a to remove non-sedimenting reaction products from the recirculating electrolyte 105a.

### Example 3—CO₂ Removal

This example relates to an integrated approach for removing a portion of one contaminant gas from a first gas stream using electrochemically generated ions to react with and sequester said contaminant gas under a set pH level. In particular, the example relates to removing CO₂ from a feed gas analogous to raw biogas.

As illustrated in FIG. 3, the CO₂ removal was conducted in a modified glass bottle with a total volume of 325 mL in a fume hood in a temperature-controlled (22±1° C.) laboratory. The reactor was sealed to ensure gas-tightness and mixed by a magnetic stirrer at a speed of 300 rpm. Two iron plates (Mild steel, Harding steel), served as anode and cathode, respectively, were placed in parallel and fixed to the lid of the bottle, with an interelectrode gap of 1.0 cm. The dimensions of iron plates were 15 cm×1.4 cm×0.3 cm. Each iron plate was submerged at a depth of 3.5 cm in the electrolyte, achieving a submerged surface area of 11.9 cm². Iron oxidation was achieved by controlling the current of electrochemical cell via a bench power supply (72-2685, TENMA, China). pH in the reactor was monitored with a portable pH meter (miniCHEM, Labtek). The reactor has sampling ports for gas, liquid, and solid sampling, as illustrated in FIG. 3.

In each test, 200 ml of 2 g/L of NaCl solution was prepared using tap water as the electrolyte. The electrolyte was sparged with simulated biogas (with N₂ used as a proxy of CH₄ in most tests to reduce laboratory risks; N₂ and CH₄ have similarly low solubility) for about 30 min at a flow rate of 0.1 L/min, to remove the dissolved oxygen (DO) therein before the test was conducted.

The simulated biogas was transported from the gas cylinder to the reactor via a gas flow controller (EL-FLOW, Bronkhorst). The air diffuser for delivering air into the electrolyte was a needle with 0.5 mm in diameter in reactor. The feed gas was a combination of ˜60% N₂ and ˜40% CO₂ used to mimic the composition of raw biogas which typically comprises ˜60% CH₄ and ˜40% CO₂. As the electrolytic process does not react with neither CH₄, nor N₂, the results obtained are analogous to feeding raw biogas. The flowrate of the feed gas was controlled by a gas flow controller (Bronkhorst, Netherlands), and the ‘upgraded gas’ was collected with a 5 L gas bag that was connected to the outlet of reactor.

### Example 3—Experiment

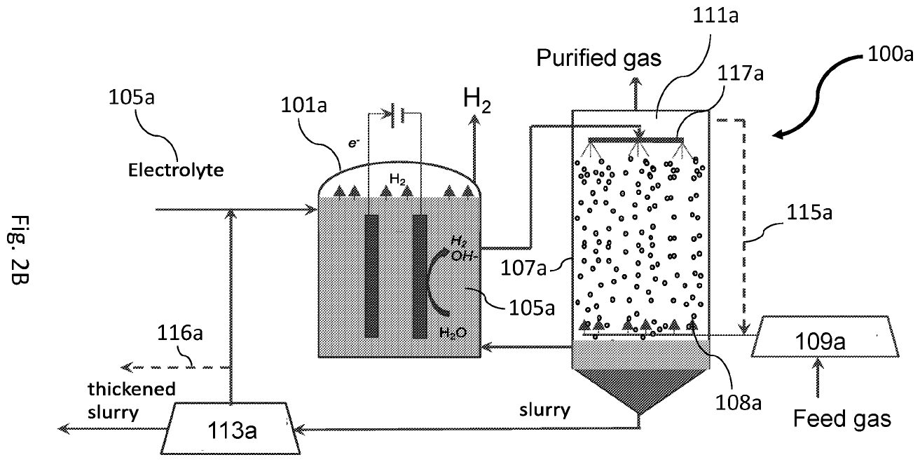

FIG. 4a presents the profiles of the gas composition (i.e., H₂, N₂ and CO₂) within the headspace of the batch testing container, pH, total iron concentration, and the current and voltage of the reactor, when the test is conducted at pH 7.5. Following sparging with the feed gas prior to time 0, the headspace comprised ˜60% N₂ and ˜40% CO₂, consistent with the known composition of the simulated biogas. As seen in FIGS. 4b and 4d, the pH at time 0 was 4.5±0.1, lower than the initial pH of the electrolyte (˜5.8), due to acidification caused by CO₂ dissolution. In the preparatory phase, a current of 0.12 A was applied, leading to H₂ formation, accompanied by a pH rise due to simultaneous hydroxide production at the cathode, reaching 7.3±0.1 in one hour, and 7.5±0.0 at the end of the preparatory phase. As indicated by the decrease of its concentration in the headspace, CO₂ in the headspace back-diffused into the liquid phase, remaining in the liquid presumably as dissolved CO₂—bicarbonate and carbonate, the latter precipitating with Fe²⁺ produced at the anode.

The content of Na in the headspace progressively decreased in the preparatory phase due to the dilution caused by H₂, which was produced at a rate higher than the CO₂ removal rate. At the end of the preparatory phase, the total iron concentration reached 1.2±0.1 g/L, evidencing iron ion production at the anode.

During the experimental phase, the feed gas is supplied to the reactor at a rate of 5 mL/min from the beginning of the experimental phase. To maintain pH 7.5, the current of electrochemical cell is also elevated from 0.12 A to 0.27±0.01 A, alongside an increase in operational voltage from 2.44±0.01 V to 6.03±0.01 V.

After a transient period of two hours, the contents of H₂, N₂ and CO₂ reached steady state, and remained stable in the last two hours.

### Example 3—Results

As summarised in Table 1 below, the CO₂ content in the headspace once reaching steady state was 9.1±0.1%, markedly lower than the value of raw gas (i.e., ˜40%). Accordingly, the CO₂ removal efficiency was calculated to be 76.6±0.2%.

TABLE 1
Summary of results of CO₂ removal at pH 7.5

| | | |
|---|---|---|
| Inflow gas composition (%) | N₂ | 60.2 ± 0.2 |
| | CO₂ | 39.8 ± 0.2 |
| Outflow gas composition (%) | N₂ | 59.1 ± 0.4 |
| | H₂ | 32.5 ± 0.4 |
| | CO₂ | 9.1 ± 0.1 |
| CO₂ removal efficiency (%) | | 76.6 ± 0.2 |
| Total iron concentration (g/L) | | 6.0 ± 0.1 |
| Coulombic efficiency (%) | | 93.2 ± 0.8 |
| Iron usage efficiency (%) | | 87.1 ± 0.2 |
| TIC/total iron (%) | | 84.1 ± 1.8 |

As shown in FIG. 4c, the total iron concentration increased linearly across the duration of the experimental phase, reaching 6.0±0.1 g/L comprising 5.8±0.1 g/L and 0.2±0.1 g/L of Fe²⁺ and Fe³⁺, respectively.

The iron usage efficiency, which is calculated as the ratio between the total amount CO₂ removed (in moles) and the total amount of iron produced (also in moles), is 87.1±0.2%, suggesting that the majority of the Fe²⁺ produced was used for CO₂ removal. The iron consumption is supported by the TIC (in moles) to total iron (in moles) ratio in the solids collected from the batch reactor, which was 84.1±1.8%.

The results demonstrate the feasibility of achieving CO₂ removal by using an iron-oxidising electrochemical cell. The results also showed part of produced ferrous ions are not combined with carbonate (approx. 15%)—suggesting that some other iron compounds, such as ferrous hydroxide, may have been formed during the experimental period.

### Example 4—CO₂ Removal at Differing pH

The efficacy of the CO₂ removal is also evaluated at pH 7.5, 8.0, 8.5 and 9.0 in a series of batch tests. Initially, 200 ml of oxygen-free electrolyte is added into the reactor, leaving 125 mL as the headspace. In the preparatory phase, a current is supplied to the cell in the absence of a gas supply. pH in the reactor was progressively elevated to the pre-specified level (i.e., 7.5, 8.0, 8.5 or 9.0) due to the on-going production of ferrous ions and hydroxide (along with H₂) in the cell. The gas-upgrade reaction is commenced when the pH set-point is reached, during which the contaminated feed gas is fed into the reactor at a rate of 5 mL/min. The current of experimental phase is further manually adjusted so that the pH was maintained at the set-point (i.e., 7.5, 8.0, 8.5 or 9.0). Once the reaction reaches a steady state at a corresponding current and/or voltage, the pH of the reactor becomes substantially self-regulating as the total concentration of hydroxide ions are maintained due to the following reactions occurring concurrently:

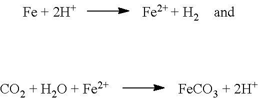

Gas samples are taken from the headspace of the reactor with a 100 μL syringe hourly in the first 4 h, and then every half hour in the last 2 h. The liquid and solid samples are taken hourly for the analysis of iron concentration.

### Example 4—Results

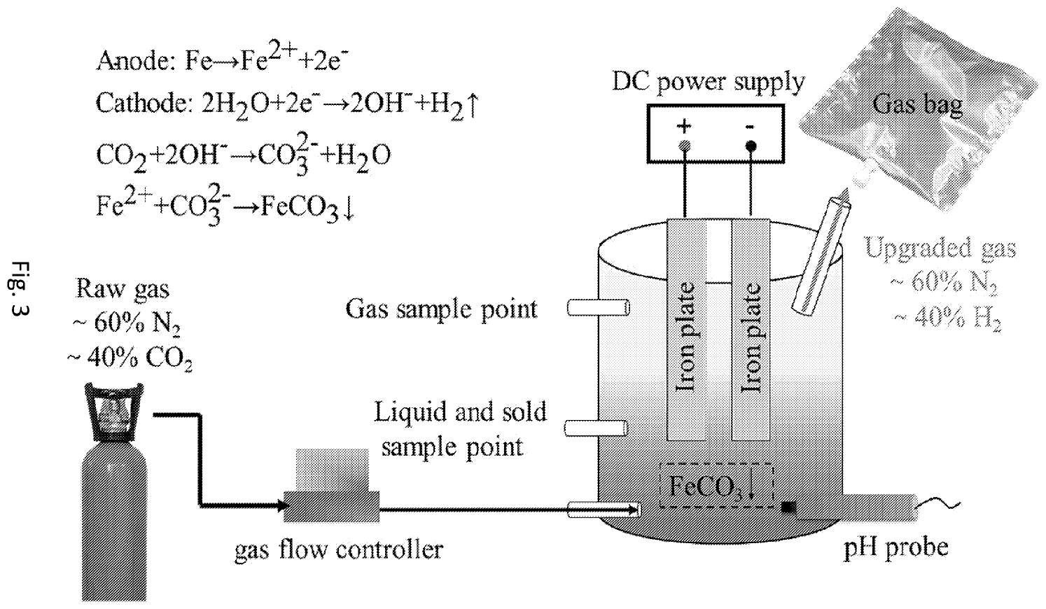

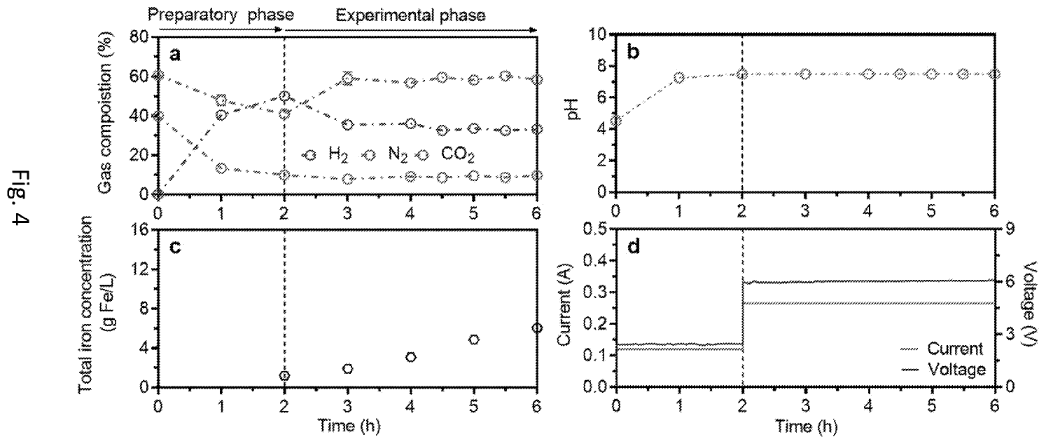

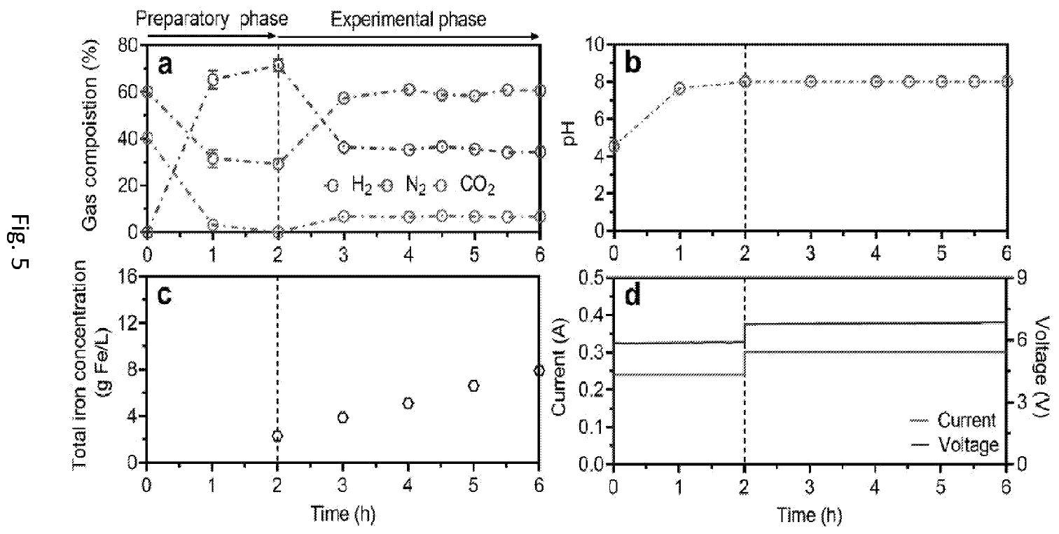

Further to FIG. 4 showing the results at pH 7.5, the results from electrochemical feed gas purification at three more targeted pH levels-namely pH 8.0, 8.5 and 9.0 are illustrated in FIGS. 5, 6 and 7, respectively. Moreover, a comparison between the different pH levels is provided in FIG. 8, which compares the headspace gas composition (i.e., H₂, N₂ and CO₂), CO₂ removal efficiency, total iron concentration, coulombic efficiency, molar ratio of TIC to total iron, iron usage efficiency, the cell voltage and current. The gas compositions and test results are also summarised below in Table 2.

TABLE 2
Summary of results of CO₂ removal at various pH levels

| | | Target pH | | |
|---|---|---|---|---|
| | | 8.0 | 8.5 | 9.0 |
| Inflow gas composition (%) | N₂ | 60.2 ± 0.2 | 60.2 ± 0.2 | 60.2 ± 0.2 |
| | CO₂ | 39.8 ± 0.2 | 39.8 ± 0.2 | 39.8 ± 0.2 |
| Outflow gas composition | N₂ | 60.0 ± 0.5 | 59.5 ± 0.2 | 60.4 ± 0.6 |
| (%) | H₂ | 34.7 ± 0.2 | 34.6 ± 0.2 | 36.1 ± 0.4 |
| | CO₂ | 6.6 ± 0.5 | 5.9 ± 0.2 | 5.0 ± 0.0 |
| CO₂ removal efficiency (%) | | 83.3 ± 1.2 | 85.1 ± 0.4 | 87.4 ± 0.1 |
| Total iron concentration (g/L) | | 7.9 ± 0.2 | 9.2 ± 0.1 | 12.2 ± 0.1 |
| Coulombic efficiency (%) | | 91.4 ± 0.3 | 95.8 ± 1.9 | 92.8 ± 1.3 |
| Iron usage efficiency (%) | | 81.2 ± 1.2 | 80.1 ± 0.8 | 53.7 ± 0.8 |
| TIC/total iron (%) | | 82.9 ± 2.3 | 82.1 ± 2.0 | 61.3 ± 1.9 |

Compared to the results at pH 7.5, lower CO₂ composition in the headspace gases is achieved, decreasing from 76.6±0.2% at pH 7.5 to 6.6±0.5% at pH 8.0, 5.9±0.2% at pH 8.5 and 5.0±0.0% at pH 9.0. This led to a corresponding improvement in CO₂ removal efficiency, as outlined above in Table 2.

By contrast, the iron usage efficiency decreased as pH increased, which was supported by the decrease in the TIC to total iron ratio in the generated iron compounds. These results support the view from Example 3 that an increasing fraction of ferrous ions combined with hydroxide rather than with carbonate as the pH is increased. In particular, a sharp decrease in the iron utilisation efficiency is observed between pH 8.5 to 9.0. Similarly, the cell voltage and current increased with the elevation of cell pH.

Overall, pH 8.5 appears to be a favourable condition with a relatively high CO₂ removal efficiency (i.e., 85.1±0.4%) and Columbic Efficiency (i.e., 95.8±1.9%), and satisfactory iron usage efficiency (i.e., 80.1±0.8%).

### Example 5—NH₃ and H₂S Removal in Methane-Containing Biogas

Another test was carried out using the gas containing ˜60% CH₄ and ˜40% CO₂, and trace NH₃ and H₂S as the feed gas of the electrochemical cell. The feed gas content substantially mimics that of raw biogas obtainable from wastewater treatment processes. The operational procedure of this test is similar to that of above-described CO₂ removal experiment conducted at pH 8.5, with the sole difference being the difference in feed gas.

### Example 5—Results

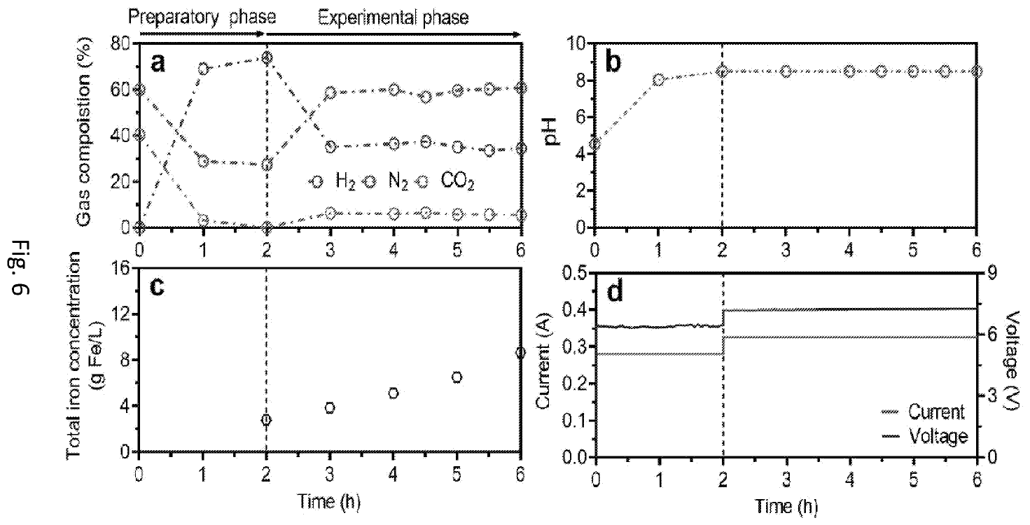

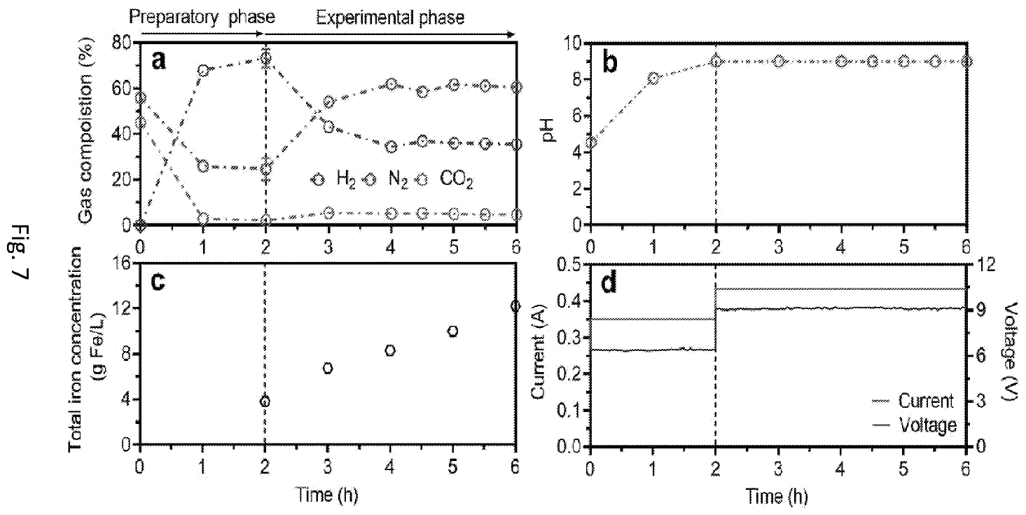

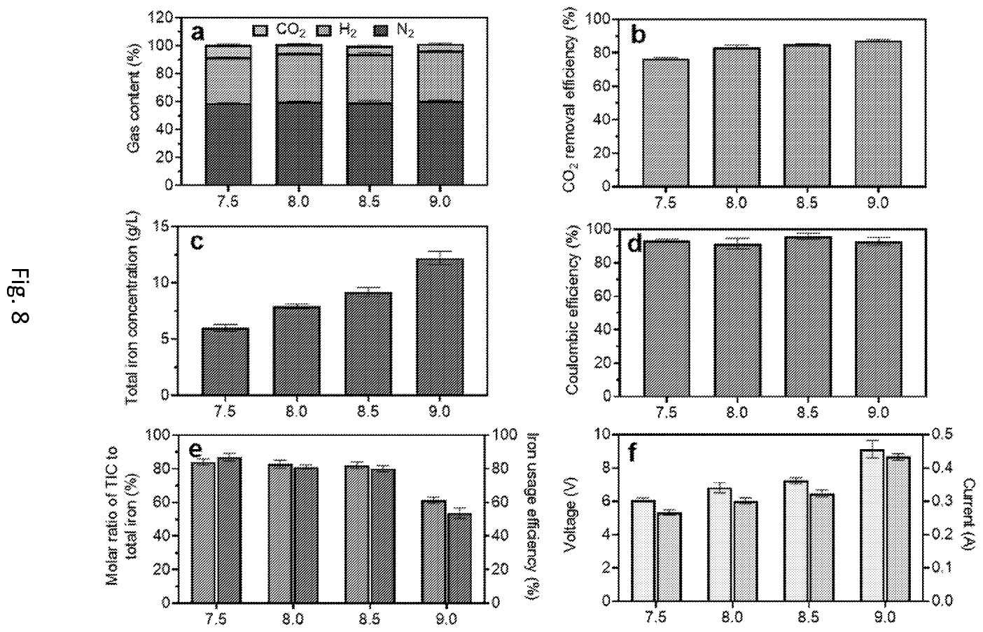

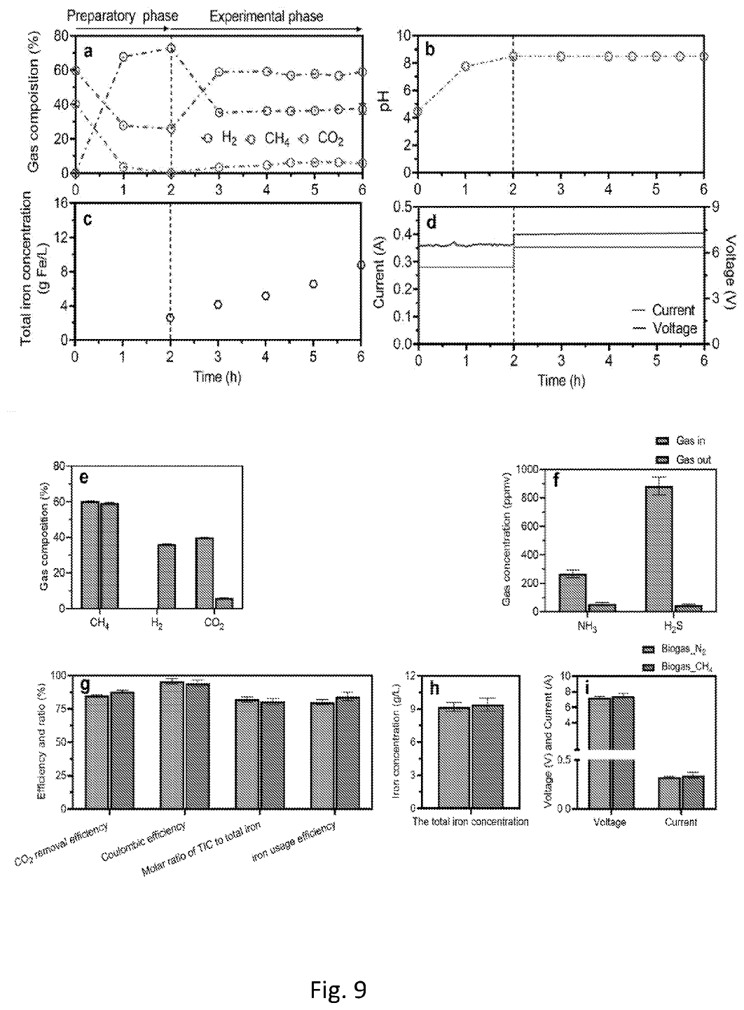

As depicted in FIG. 9a, CO₂ in the raw gas is efficiently removed at a removal efficiency of 87.9±1.3%, while the content of CH₄ hardly changes during electrochemical purification. Overlaying the results obtained from electrochemically purifying methane-containing containing feed gas with the equivalent test performed at pH 8.5 in Example 4, as done in FIGS. 9g, 9h and 9i, the differences across various performance factors including purification performance are insignificant.

The above results obtained from the methane-containing feed gas suggests that the results obtained in the batch electrochemical purification of the N₂-containing feed gas is representative of corresponding purification of raw biogas from wastewater treatment processes. In addition, FIGS. 9e and 9f shows that the toxic NH₃ and H₂S in raw gas can also be efficiently removed by the electrochemical process performed at pH 8.5. The average concentrations of NH₃ and H₂S in the feeding gas were 267.5±26.1 ppmv and 884.1±63.5 ppmv, in contrast to that of 54.3±12.3 ppmv and 46.2±6.8 ppmv in the outlet gas. These represent the decreases of 78.7±10.2% in NH₃ and 94.8±6.1% in H₂S between the inlet and outlet gas.

### Example 6—Effect of Gas Flowrate

One of them aimed to evaluate the effect of gas flow rate on the cell performance. The test lasted for 9 h, comprising a 2 h preparatory phase with pH elevated to 8.5 in the absence of a gas supply, and a 7 h experimental phase, during which the gas flow rate was stepwise increased from 2 mL/min (3 h), 5 mL/min (2 h), and 10 mL/min (2 h). Gas samples were taken hourly in the first 4 h, and then every half hour in the following 5 h.

### Example 6—Results

The CO₂ removal efficiency of the electrochemical system was investigated with different feed gas flow rates at pH 8.5. After a transmission period following each change in the feed gas flow rate, FIG. 10a shows that the CO₂ concentration increases with the gas flow rates from 3.2±0.3% at 2 mL/min, to 6.2±0.1% at 5 mL/min, and then to 9.5±0.5% at 10 mL/L. In the corresponding FIG. 10b, the CO₂ removal efficiency decreased significantly from 92.0±0.8% to 83.8±0.4% and finally to 74.0±0.3%.

The results suggest that the increase in the gas flow rate resulted in a reduced gas residence time, and thus the CO₂ reaction time. The reduction in time for the gaseous CO₂ to dissolve and react with the iron ions led to a decline in the CO₂ removal efficiency. Accordingly, it is speculated that CO₂ removal from biogas can be maximised with complementary reactor design and gas flowrates such that a satisfactory gas retention time is achieved.

### Example 7—Particle Analysis and Characterisation

In this example, particle analysis was performed on the FeCO₃ precipitates formed from electrochemically purifying a CO₂-containing feed gas at pH 8.5, as per the present invention. XRD analysis was performed on about 50 ml of the Fe-containing slurry, using an X-ray diffractometer (Bruker D8). Prior to XRD measurements, the Fe-containing slurry was dried under vacuum conditions (−50° C., 0.1 mbar), and then ground into powder under anaerobic conditions to prevent oxidation.

Furthermore, particle size measurements using 3 ml sample were performed on the freshly produced slurry and the slurry stored for 1, 2 and 4 weeks. Particle size was measured using dynamic light scattering (Zetasizer Nano ZS, Malvern Instruments).

### Example 7—Results

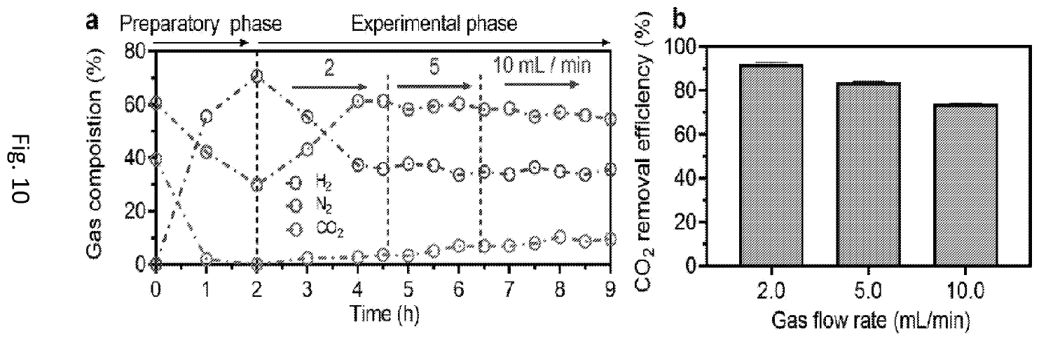

FIG. 11 represents the XRD pattern of the Fe-containing slurry produced at pH 8.5 condition. Three crystalline iron species in the Fe-containing slurry were identified, including siderite (FeCO₃), Goethite (α-FeO(OH)) and Hematite (Fe₂O₃). Siderite was formed by the precipitation reaction of carbonate and Fe²⁺. Goethite and hematite were also detected in the slurry, which is consistent with previous results, indicating that the slurry contained some Fe³⁺ ions produced during electrolysis within the cell.

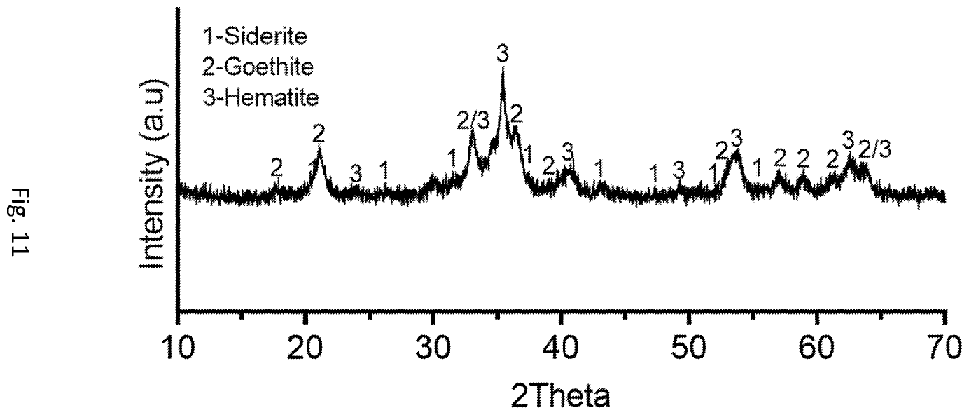

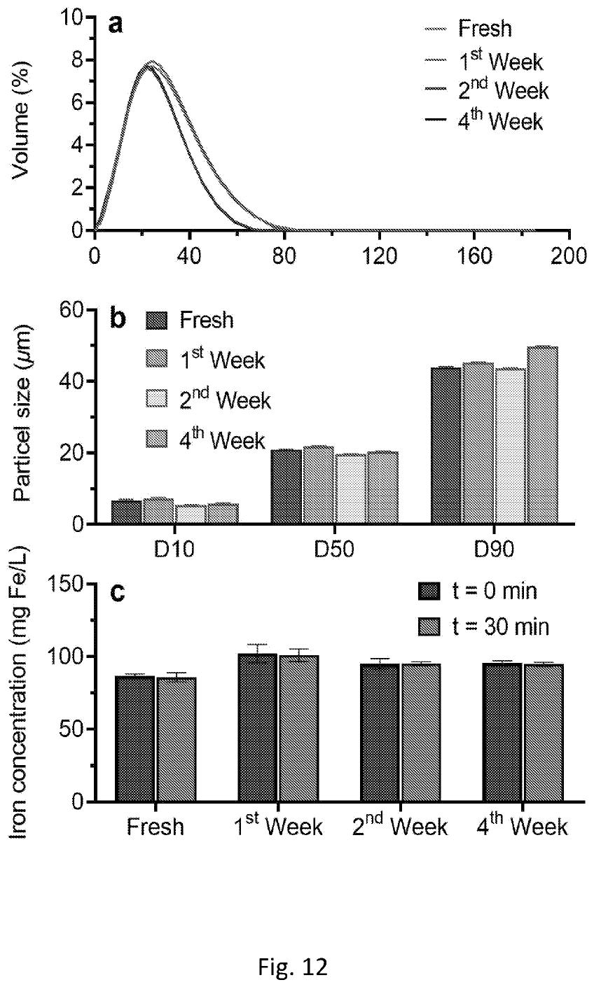

FIG. 12 represents the particle size distribution and suspension performance of the FeCO₃ precipitates (produced in pH 8.5) at various ages post-precipitation. The particles were stable with nearly identical particle size distribution profiles (FIG. 12a) and D₁₀, D₅₀ and D₉₀ values (FIG. 12b), representing 10, 50 and 90 percentiles of the particle sizes. These results indicate long term storage of the products would not lead to significant particle aggregation or breakup. Results of settleability performance test confirmed that the FeCO₃ slurry substantially do not settle under the typical turbulent conditions in sewers (FIG. 12c), regardless of their age. These results suggest that the FeCO₃ precipitates remain substantially suspended in sewage after in-sewer dosing, making in-sewer dosing upstream of a wastewater treatment plant feasible and effective.

### Example 8—Sulfide/Phosphate Removal

In this example, the suitability of FeCO₃ produced in biogas upgrading for supporting urban wastewater management was investigated across several batches. The FeCO₃ slurry collected from the reactors after upgrading the feed gas and/or biogas is directly dosed in batches simulating a sewer, an aerated biological treatment process as well as an anaerobic digestor to ascertain its effect on sulfide and phosphate concentrations.

Sewer conditions are established by using wastewater collected from a local domestic wastewater pumping station (Brisbane, Australia). The wastewater initially contains a total COD at 400-600 mg/L, soluble COD at 220-310 mg/L, phosphate at 4-7 mg P/L, iron at 0.1-0.3 mg Fe/L, sulfate at 10-20 mg S/L, sulfide at 5-10 mg S/L, and negligible levels of sulfite and thiosulfate. The wastewater has a pH of 7.1-7.4 and contains an undetectable level of oxygen.

For the sewer-mimicking tests, a pre-determined amount of the FeCO₃ slurry is added to each bottle to achieve a pre-designed initial iron concentration. To guarantee there is no gas headspace during the experiment period, two syringes filled with filtered raw oxygen-free wastewater are connected to the reactor to replenish the reactor after sampling.

All experiments mimicking biological wastewater treatment system are conducted using activated sludge collected from a local WWTP (Brisbane, Australia). The mixed liquor suspended solids (MLSS) and mixed liquor volatile suspended solid (MLVSS) concentrations of the collected activated sludge are 13.2±0.1 g/L and 10.6±0.1 g/L, respectively. In the experiments mimicking anaerobic digestion, the used inoculated digested sludge is sourced from a laboratorial anaerobic digestion reactor, with the MLSS and MLVSS concentrations of 20.6±0.1 g/L and 16.3±0.1 g/L, respectively. The FeCO₃ slurry obtained via biogas purification at pH 8.5 is used.

The above batches use both freshly produced FeCO₃, i.e., with the tests undertaken within one day following the FeCO₃ production, and FeCO₃ slurries stored in a further sealed serum container at a temperature-controlled (22±1° C.) laboratory for 1, 2 and 4 weeks to determine the impact of FeCO₃ storage on the sulfide removal performance.

### Example 8.1—Sulfide Removal from Sewers

For each in-sewer sulfide removal batch, 290 mL of the wastewater prepared above is filtered using disposable Millipore filter units (0.45 μm), and then transferred into a 300 mL sealed container. Prior to the experiment, the container is exposed to pure nitrogen gas for 30 min to further remove dissolved oxygen. A sulfide stock solution (Na₂S·9H₂O of ˜1.5 g S/L) of 5 mL is then added to the bottle to increase the sulfide concentration to approximately 25 mg S/L, followed by the addition of 1M HCl to obtain a pH to 7.2, simulating domestic wastewater.

Two levels of initial Fe levels, namely 30 and 90 mg Fe/L, are used in the separate above-described batches. According to reaction stoichiometry, an initial Fe concentration of 30 mg/L is insufficient for removing the sulfide initially present in the wastewater (˜25 mgS/L), and hence the ratio between sulfide removed and Fe added is determined. In contrast, an initial Fe of 90 mg/L is in excess, and hence the lowest achievable sulfide concentration is identified.

Each sulfide removal test lasts for 3 h, during which the reactor is mixed by a magnetic stirrer at 300 rpm. Liquid samples are taken before FeCO₃ dosing, and every 15 mins in the first hour after the dosing, and then every 30 mins, for the measurement of dissolved sulfide concentration. pH in the reactor is monitored with a portable pH meter and recorded manually with the same intervals. An additional sample is taken at the end of each test for the measurement of the total iron concentration.

### Example 8.1—Results

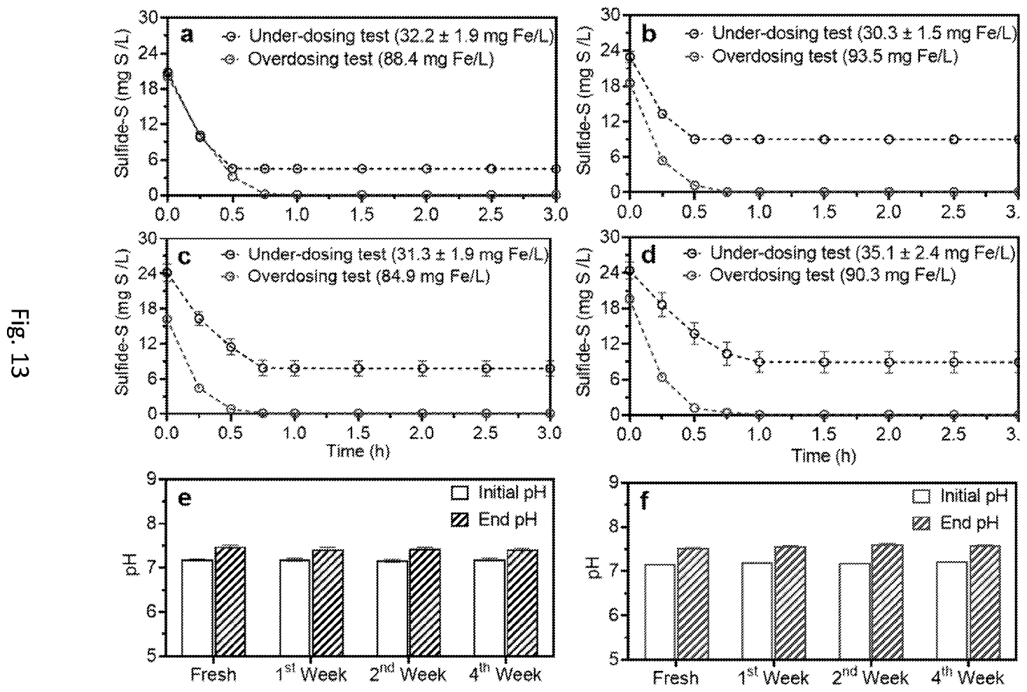

FIG. 13a shows the results of sulfide removal from conditions akin to sewers using the FeCO₃ slurry freshly produced at pH 8.5. By dosing FeCO₃ slurry at a concentration of 32.2±1.9 mg Fe/L, the dissolved sulfide concentration decreased from the initial 20.8±0.3 mg S/L to 4.6±0.3 mg S/L in 0.5 h and remained at this level for the remaining period of the 3 h experiment. The ratio between the sulfide removal and the dosed Fe was 0.51±0.04 g S/g Fe. This is close to the theoretical stoichiometric ratio of 0.57 mgS/mg Fe (HS⁻+Fe²⁺→FeS+H⁺). Meanwhile, the pH of wastewater was raised from initial 7.18±0.02 to 7.48±0.03 within 3 h, caused by the release of carbonate from FeCO₃. The increase of pH can promote sulfide and Fe²⁺ precipitation and can provide more alkalinity for downstream nitrification processes. This is in contrast with dosing FeCl₂ or FeCl₃, which is known to reduce the pH of sewage as their hydrolytic process will release some protons.

To identify the achievable minimum concentration of dissolved sulfide by dosing obtained FeCO₃ slurry, another sulfide removal batch test was conducted via overdosing the FeCO₃ slurry. FIG. 13a showed that, by dosing FeCO₃ at a concentration of 88.4 mg Fe/L to the wastewater containing 20.1 mg S/L of sulfide, the dissolved sulfide concentration sharply reduced to 3.2 mg S/L within 0.5 h, and then to 0.08±0.00 mg S/L within 3 h, the efficiency of the sulfide removal reaching 99.5%.

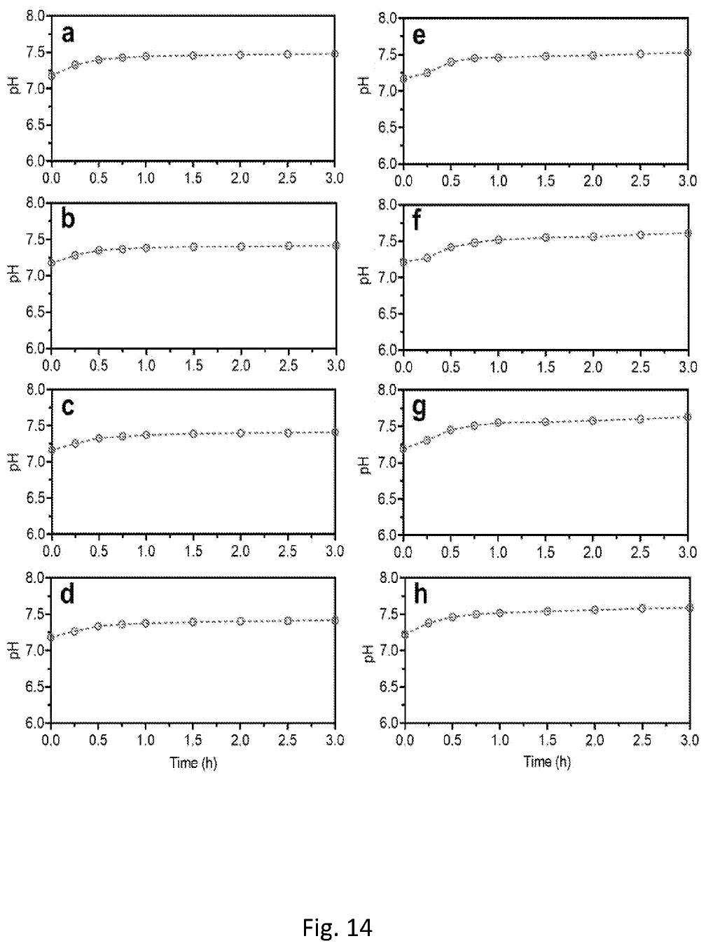

These results suggest that by using electrochemically produced FeCO₃, sulfide can be removed to very low levels (<0.1 mg/L) in overdosing conditions, which is comparable to the sulfide removal effects of FeCl₂ and FeCl₃ used in the art. As shown in FIG. 14e, using the same testing period, the pH of wastewater increased from 7.17 to 7.40, and then to 7.53. One of the reasons for the low sulfide levels achieved was the pH elevation along with sulfide precipitation, the former favouring ferrous (II-valent) sulfide precipitation.

As shown in FIGS. 13b to 13d, the obtained FeCO₃ slurry stored for 1, 2 and 4 weeks showed similar sulfide removal performance to that of the freshly purified batch (FIG. 13a). Results showed that, after storage for 1, 2 and 4 weeks, FeCO₃ slurry still can remove the majority of sulfide within one hour, and the ratio between the sulfide removal and the dosed Fe were 0.46±0.02 g S/g Fe, 0.51±0.03 g S/g Fe, and 0.48±0.02 g S/g Fe, respectively. It was also shown that FeCO₃ particles stored for 4 weeks are still effective in reducing sulfide concentration to below 0.1 mg S/L, while also increasing the wastewater pH from ˜7.2 to ˜7.5 to aid with the reduction of sulfide (as seen in FIG. 14).

Overall, the FeCO₃ particles produced from the electrochemical biogas purification were effective in removing sulfide, regardless of storage period, as well as simultaneously providing alkalinity for downstream nitrification process.

### Example 8.2—Phosphate Removal

For each phosphate removal test, activated sludge of 100 mL is mixed with the 400 mL filtered wastewater identical to that used in the sulfide removal tests. A phosphate stock solution (5 g P/L of KH₂PO₄) of 1.5 mL is then added to the sludge and wastewater mixture to increase the phosphate concentration to about 20 mg P/, after which the phosphate-containing wastewater is separated into test batches. Amounts of about ˜0.8 and ˜3.5 mL of FeCO₃ slurry (˜10 g Fe/L) is dosed to each batch to obtain two levels of initial Fe concentrations, namely approx. 16 mg and approx. 70 mg Fe/L, respectively, as well as a control batch without any dosed iron.

Each test is run for 6 h, during which the DO concentration of reactor is controlled at 2.0-3.0 mg O₂/L by a programmable logic controller (PLC) via on/off control of the air flow. The reactor is mixed by a magnetic stirrer at 300 rpm. In a similar procedure to the sulfide removal, liquid samples are taken before FeCO₃ dosing, and every 0.5 h in the initial two hours, and then hourly, for the measurement of phosphate concentration. pH of the reactor was monitored with a portable pH meter and recorded manually with the same intervals. An additional sample was also taken at the end of each test for the measurement of the total iron concentration.

### Example 8.2—Results

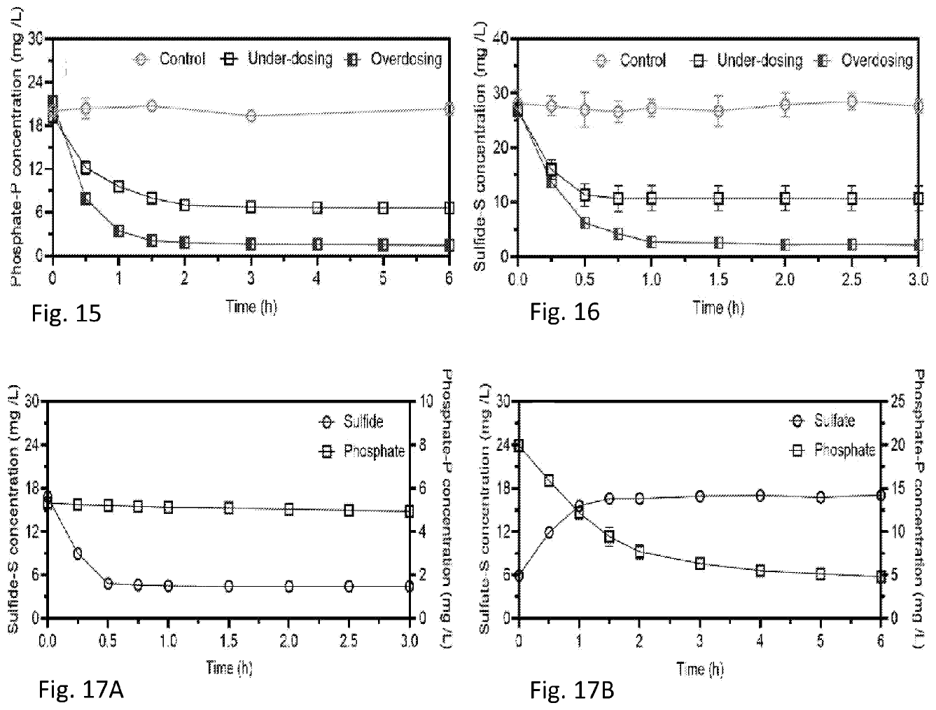

As seen in FIG. 15, the measured dissolved phosphate concentration reduced from 19.2±0.1 mg P/L to 9.7±0.3 mg P/L within 1 hour and then decreased to 6.7±0.3 mg P/L within 6 hours after adding FeCO₃ at a concentration of 24.3±2.1 mg Fe/L. The results suggest that the decrease in phosphate concentration was caused by dosing FeCO₃. The ratio between the phosphate removal and the dosed Fe was 0.56±0.02 g P/g Fe, while the pH values of the control and experimental reactors were 7.43±0.02 and 7.86±0.02, respectively.

The achievable minimum concentration of phosphate was identified to be 1.41±0.08 mg P/L, demonstrated by overdosing the electrochemically produced FeCO₃ slurry at a concentration of 92.3±3.4 mg Fe/L to the activated sludge reactor containing 21.4±0.3 mg P/L of phosphate.

### Example 8.3—Sulfide Removal from an Anaerobic Digestor

For each test removing sulfide from an anaerobic digestor, inoculated digested sludge of 50 mL is added into a 100 mL sealed bottle, then deoxygenated with pure nitrogen gas for 10 mins. A sulfide stock solution (˜1.5 g S/L of Na₂S·9H₂O) of 1.0 mL is added to the bottle to increase the sulfide concentration to about 30 mg S/L, followed by the addition of some 1M HCl to achieve the pH to 7.5, typical of anaerobic digestion.

FeCO₃ slurry (approx. 10 g Fe/L) of about 0.15 and 0.45 mL are then dosed into the sludge batches to increase the initial iron concentration to approximately 30 and 90 mg Fe/L, respectively, while one control batch is left un-dosed.

Each test lasts for 3 h, during which the reactor is mixed by a magnetic stirrer at 300 rpm. Sludge samples are taken before FeCO₃ dosing, and every 15 mins in the first hour after the dosing, and then every 30 mins, for the measurement of dissolved sulfide concentration. pH in the reactor is monitored with a portable pH meter and recorded manually with the same intervals. An additional sample is taken at the end of each test for the measurement of the total iron concentration.

### Example 8.3—Results

As FIG. 16 shows, the addition of FeCO₃ slurry at 32.2±1.9 mg Fe/L, resulted in a reduction in dissolved sulfide concentrations from the initial 26.9±0.5 mg S/L to 11.6±1.4 mg S/L by the half-hour mark, and maintained this concentration for the remaining 2.5 hours. The successful removal of sulfide from the sludge resulted in a ratio between the sulfide removal and the dosed Fe of 0.41±0.03 g S/g Fe. By overdosing FeCO₃ at a concentration of 95.5±3.8 mg Fe/L, the achievable minimum dissolved sulfide concentration was observed to be 1.41±0.08 mg S/L.

### Conclusion—Example 8

Overall, the tests indicate that the electrochemically produced FeCO₃ slurry containing FeCO₃ particles can support the urban wastewater management at a comparable efficiency to adding commonly used iron salts containing soluble iron ions, specifically in terms of controlling sulfide in sewers and anaerobic digestors, as well as phosphates in biological wastewater treatment systems. The in-situ production of FeCO₃ slurry through the electrochemical biogas purification process allows any such integrated WWTP system to avoid costly and hazardous transportation of corrosive concentrated iron salt solutions otherwise required.

### Example 9—FeCO₃ Flow on Effects

Urban wastewater system is an integrated system, including a sewer network followed by an aerated biological wastewater treatment unit, and an anaerobic wasted sludge digestion unit. In this example, the impacts of dosing FeCO₃ slurry to a sewer network on the performance of downstream biological wastewater treatment units and waste sludge digestion units were investigated by a series of batch experiments.

This example utilises procedures similar to that of the in-sewer sulfide removal tests of Example 8.1, other than only one-day-old FeCO₃ slurry being used at under-dosing conditions in order to avoid the impacts of residual iron on the downstream performance of wastewater treatment system. The initial sulfide and Fe concentration in this test are approximately 18 mg S/L and 20 mg Fe/L, respectively.

After the sulfide removal test of Example 8.1, all of the remaining 300 mL FeCO₃ slurry amended sewage was mixed with 300 mL of activated sludge which was prepared by mixing 150 mL raw activated sludge with the raw wastewater at a ratio of 1:1 (v/v). A phosphate stock solution (5 g P/L of KH₂PO₄) of 3.0 mL was then added to the bottle to increase the phosphate concentration to about 25 mg P/L. Each test lasted for 6 h, during which the same mixing and aeration conditions and the sampling procedure as that of the phosphate removal test described in Example 8.2 was applied.

The effect of in-sewer dosed FeCO₃ slurry on the performance of anaerobic digestion is also investigated over three steps, sulfide removal in sewer, phosphate removal during aerated wastewater treatment, and sulfide control in anaerobic digestion. The first two steps are similar as that of the processes tested in Example 8, however the initial sulfide, Fe and phosphate concentrations in this test are much higher than that of Example 8.2 and 8.3, utilising concentrations of approximately 200 mg S/L, 300 mg Fe/L and 300 mg P/L, respectively in order to mimic the inevitable accumulation of in-sewer dosed Fe in the sludge of the simulated WWTPs.

To simulate an aerated clarifier located within a WWTP and located downstream from in-sewer sulfide removal, a mixed liquor from the in-sewer sulfide and phosphate removal is concentrated by a centrifuge at 2500 rpm for 3 mins. With the supernatant wasted, the concentrated sludge (˜15 g VS/L) is used as the feed for biochemical methane potential (BMP) tests to measure biogas output from an anaerobic digestor.

In the third step, the effect of in-sewer dosed FeCO₃ on sulfide control in anaerobic digestion is evaluated by the BMP tests whereby the sulfide concentration in the biogas, as well as the liquid phase BMP reaction vessels is measured. In this test, about 20 mL of thickened activated sludge (from step two) is mixed with approx. 40 mL inoculated digested sludge, and then transferred into a 100 mL sealed container. A blank test is also set up using the feeding of ˜20 mL wastewater and ˜40 mL inoculated digested sludge. After deoxygenating with nitrogen gas, sulfate stock solution (Na₂SO₄ of ˜1.5 g S/L) of 1.0 mL is added into the containers to increase the sulfate concentration to about 25 mg S/L, followed by the addition of 1M HCl to adjust the pH of bottle to ˜7.5, typical of anaerobic sludge digesters. Once dosed to the initial conditions of the BMP test, all the containers are incubated in a temperature-controlled (37±1° C.) incubator for anaerobic digestion of the sludge.

Biogas released from the container is measured over 30 days, at which point almost no further biogas release was detected. A gas sample was taken every two days in the initial 10 days, and every five days to the end, for the measurement of the N₂, CH₄ and CO₂ compositions in the biogas. The volume of biogas in each sealed container was also measured at the same intervals. Gas and liquid samples were taken every 5 days for the measurement of sulfide/sulfur species and concentration. An additional sludge sample was also taken at the end of each test for the measurement of the dewaterability of sludge.

The effect of FeCO₃ dosing on settleability of activated sludge and dewaterability of the anaerobically digested sludge was measured by comparison with sludges without FeCO₃ dosing (i.e., the controls). Both SVI and SRF, indexes for sludge settleability and dewaterability respectively, were measured using method known in the art, or are standard in examining water and wastewater. In this regard, SRF was analysed by using a multi-couple measuring device known in the art.

### Example 9—Results

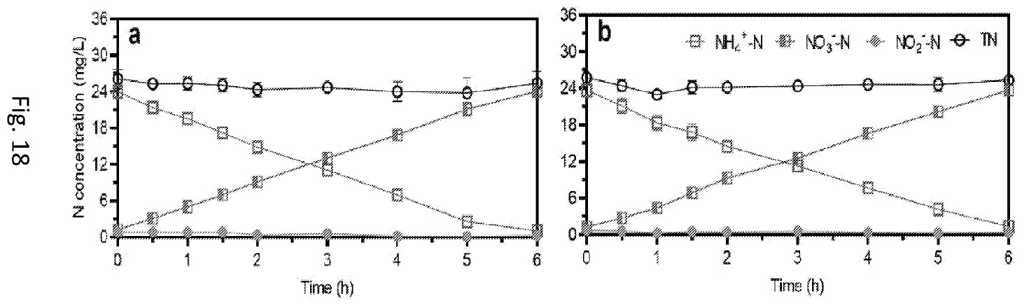

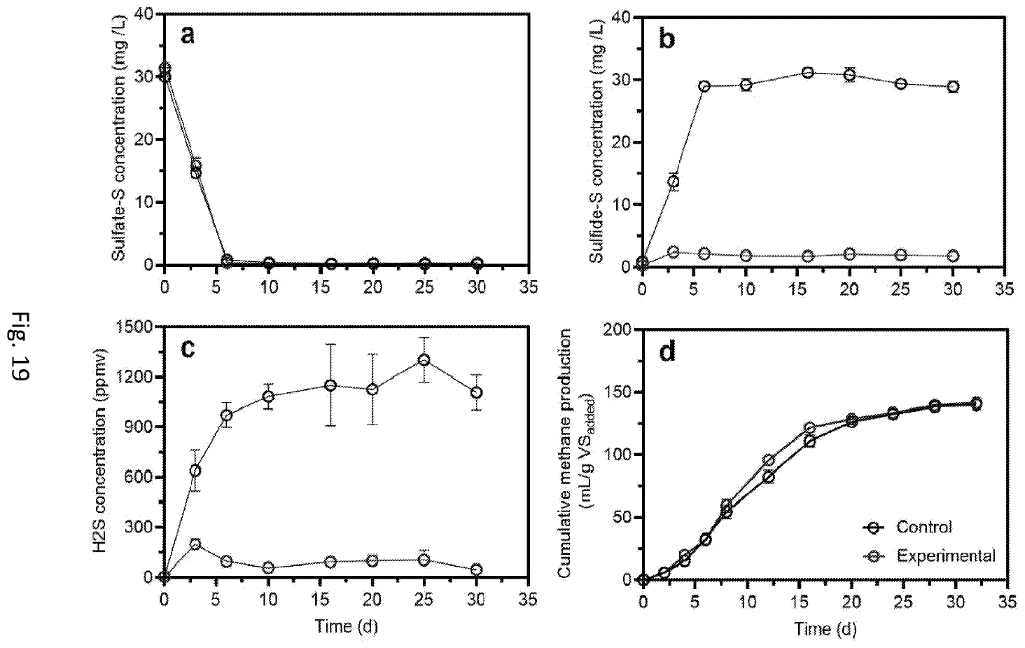

As shown in FIG. 17a, by dosing FeCO₃ slurry at a concentration of 26.3±0.7 mg Fe/L, dissolved sulfide concentration in the simulated sewer system declined from 16.9±0.2 mg S/L to 4.4±0.3 mg S/L. Albeit small in magnitude, the phosphate concentration also slowly decreased from 5.3±0.1 mg P/L to 5.0±0.1 mg P/L during this phase.

In the following aerated biological wastewater treatment process, as shown in FIG. 17b, the dissolved sulfate concentration increased from 5.9±0.3 mg S/L to 17.1±0.4 mg S/L over 6 hours, while the phosphate concentration decreased from 19.8±0.5 mg P/L to 4.7±0.3 mg P/L during the same period.

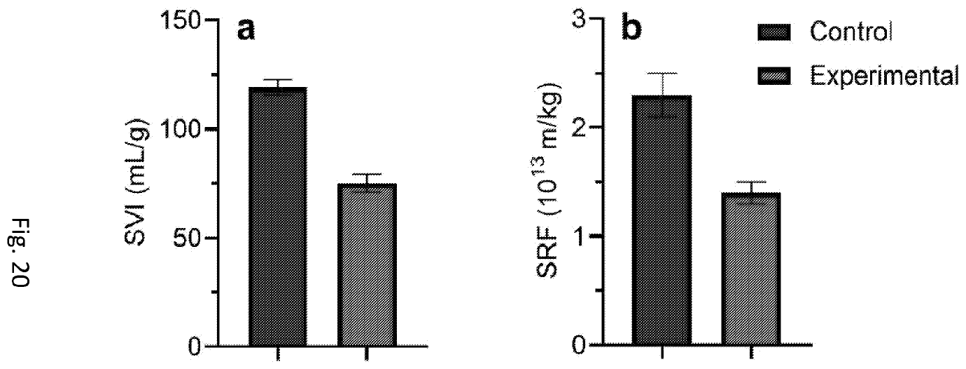

The reduction in sulfide concentration suggest that the FeS particles formed in the anaerobic sewer conditions (FIG. 17A). The increase in sulfate concentration in the aerated biological wastewater treatment process (FIG. 17B) suggests oxidation of FeS formed in sewer conditions. The sulfide is oxidized to harmless dissolved sulfate, while the released iron ions precipitated with phosphate as insoluble iron-phosphate-hydroxide complexes in the sludge, leading to the removal of dissolved phosphate. By comparison, the concentration profiles of nitrogenous compounds in the bioreactor simulating containers remained similar to that of control, as seen in FIGS. 18a and 18b respectively. This implies that the dosed FeCO₃ slurry did not impact the nitrification process.

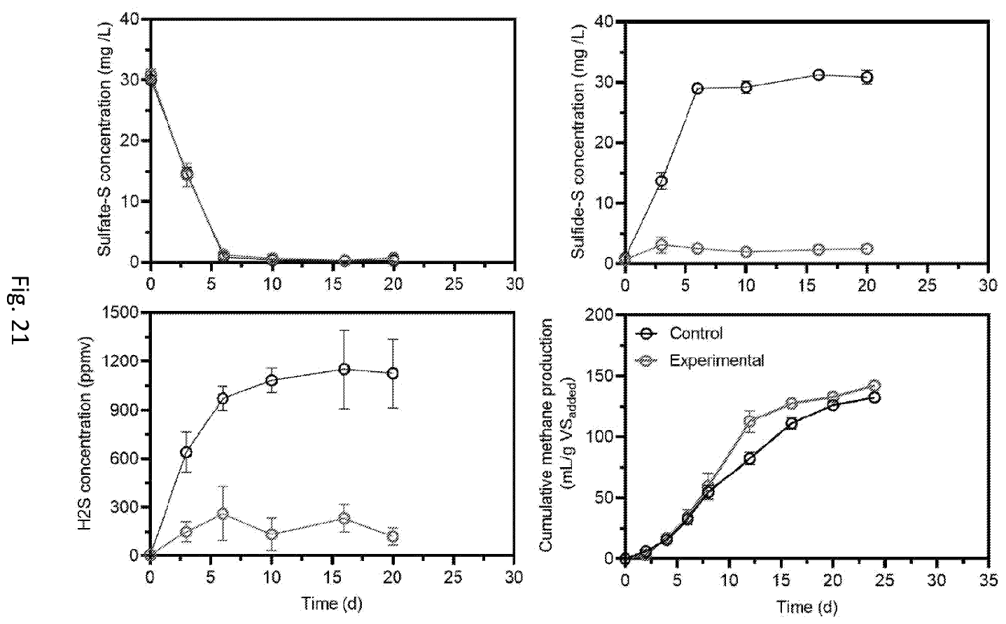

The dissolved and gaseous sulfide concentrations of the BMP sealed containers are much lower than that of the control, as shown in FIG. 19 illustrating the concentration profiles during the subsequent anaerobic digestion. The average dissolved and gaseous sulfide concentrations in experimental reactors were 1.8±0.2 mg S/L and 82.5±23.6 ppmv, in contrast to 29.1±0.6 mg S/L and 1123.7±134.5 ppmv in the control reactors. These represents relative decreases of 94.2±3.1% and 92.6±8.3% between the dissolved and gaseous sulfide concentrations of the experimental and control containers. These results imply that the iron in the iron-phosphate complexes containing sludge was regenerated in the anaerobic digester, leading to the precipitation of sulfide, thus significantly decreasing the dissolved and gaseous sulfide concentrations.

The similar profiles of methane accumulation in the headspace of experimental and control reactors are observed, suggesting that the dosed FeCO₃ slurry did not impact the methane production performance.

Furthermore, results represented in FIG. 20 also show that the settleability and dewaterability of sludge were significantly enhanced by the dosed FeCO₃ slurry. The SVI and SRF of the sludge from control reactor were 119.0±4.8 mL/g and 2.3±0.2 (1013 m/kg), respectively. These values were 75.1±4.1 mL/g and 1.4±0.1 (1013 m/kg), respectively, in the sludge from experimental container. This means the settleability and dewaterability of sludge were improved by 36.9±2.7% and 39.1±4.5%, respectively, by dosing FeCO₃ slurry.

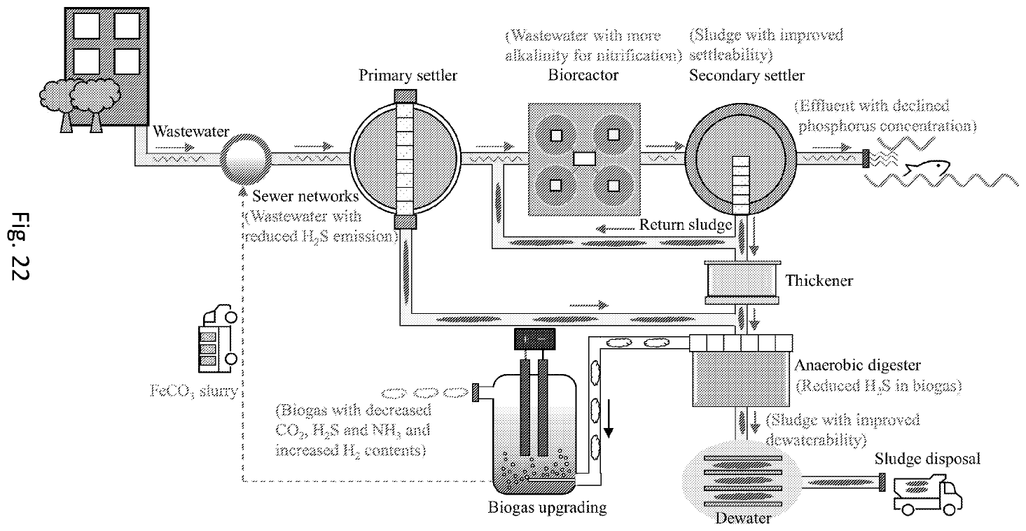

Finally, the sulfide removal and biogas production characteristics of the anaerobic digestor under in-sewer dosing (FIG. 19) is compared to the results from direct FeCO₃ dosing of the digestor, the latter shown in FIG. 21. Overall, it is clear that there are minimal to substantially no adverse effects to biogas production from upstream in-sewer dosing of FeCO₃ compared to the direct dosing seen in FIG. 21. Moreover, Considering the FeCO₃ is useful in suppressing both sulfide and phosphate concentrations upstream from the anaerobic digestor, the in-sewer dosing is clearly beneficial and preferred.

### Example 10—Application in Wastewater Treatment Plants

Considering the above flow-on benefits of dosing FeCO₃ to processes or vessel upstream from the anaerobic digestor itself, two examples of the present invention are feasible and effective.

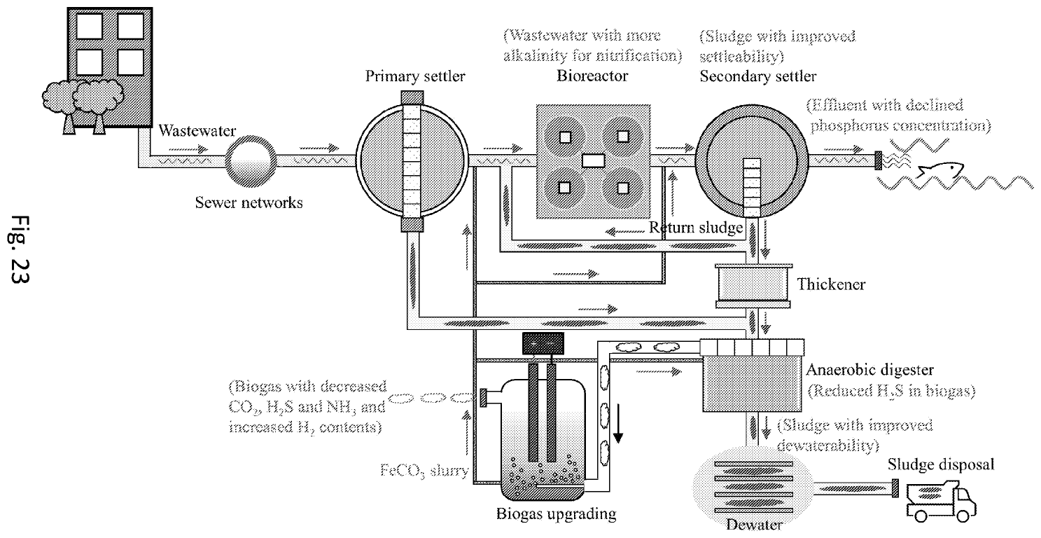

The first, illustrated in FIG. 22 shows the electrochemically produced FeCO₃ slurry being transported from the cell to the sewer network upstream from the of the wastewater treatment plant (WWTP). Such an injection of slurry would provide the full benefit of sulfide and phosphate suppression through the WWTP as per the flow-on effects observed in Example 9.

Further mass balance analysis of this embodiment suggests that minimal FeCO₃ production at the electrochemical cell is sufficient in providing significant sulfide removal benefits. In doing so, the theoretically achievable iron dosage and sulfide removal capacity were calculated based on three different influent scenarios (i.e., low-, medium-, and high-strength wastewater). Results suggest that the sulfide removal capacity can reach 10.0 mg S/L when the influent only contains 200 mg/L of COD-enough to eliminate the sulfide concentration in the typical sewage (<10 mg/L). In the scenario of influent COD concentration of 500 and 800 mg/L, the theoretical sulfide removal capacity can reach 24 and 39 mg S/L, respectively.

As shown in Example 9, upstream dosing of iron salts can notably decrease the phosphate concentration in the effluent of biological treatment reactor, significantly decline the H2S concentration in biogas of AD, and substantially improve the settleability and dewaterability of sludge. The test results confirm that dosing the electrochemically produced FeCO₃ slurry in this regard can generate and maintain these flow-on benefits to downstream wastewater treatment processes, while also increasing the pH of sewage to benefit the nitrification by the sludge.

Considering nitrification in the biological wastewater treatment reactor, and biogas production in the anaerobic digester are not adversely affected by the sewer dosing of electrochemically produced FeCO₃ from the purification of said biogas, the electrochemical system of the present invention provides an efficient and integrated system that is able to provide synergised benefits. By producing the iron salts on-site, which reduces or eliminates the need to transport materials to the site, the electrochemical FeCO₃ approach is more cost-effective than existing methods for delivering iron ions into wastewater treatment plants while also being able to purify biogas from anaerobic digestors.

In another aspect of the invention illustrated in FIG. 23, the FeCO₃ slurry is provided directly to various unit operations, including prior to the aerated bioreactor, prior to the secondary settler and/or the anaerobic digestor for mixing with the activated sludge in each operation.

As shown in Example 8, direct dosing of iron salts to sludges can notably decrease the phosphate and sulfide concentrations in the wastewater/sludge of the respective unit process. With respect to the dosing of FeCO₃ slurries before and after the bioreactor, improved settleability of the sludge is also achieved during secondary settling/clarification, as per the results of Example 8.2 and FIG. 20a.

Similarly, the direct provision of FeCO₃ slurry to the anaerobic digestor, in addition to reducing the emission of H₂S gas and during digestion, reduces the sulfide concentration of the digested sludge and improves its dewaterability for enhanced disposal. The above benefits are substantially in line with those disclosed in Example 8.3 and FIG. 20b.

Those skilled in the art will appreciate that the invention described herein is susceptible to variations and modifications other than those specifically described. It is understood that the invention includes all such variations and modifications which fall within the spirit and scope of the present invention.

1. A method for removing a portion of at least one contaminant gas from a first gas stream, the method comprising the steps of:
a) applying a voltage across an electrically connected pair of electrodes at least partially in contact with a working fluid in an electrochemical cell to generate a plurality of ions; and
b) reacting at least a portion of the at least one contaminant gas with the plurality of ions in the working fluid to convert the portion of the at least one contaminant gas to one or more reaction products, thereby sequestering at least some of the contaminant gas from the first gas stream to produce a second gas stream,
wherein the pH of the working fluid is substantially maintained at a predetermined set point for improving the efficiency of the conversion, and wherein the first gas stream comprises at least one contaminant gas selected from the group consisting of CO₂, H₂S, NH₃, NOx, and a halogen.

2. The method according to claim 1, wherein the predetermined set point is maintained by adjusting at least one of: the flowrate of the first gas stream; the voltage; and current applied across the electrodes.

3. The method according to claim 1 or 2, wherein the predetermined set point falls within the range of pH 7.5 to pH 9.0, and wherein the voltage across the electrodes is adjusted between a range of 0.5 V and 50.0 V.

4. The method according to claim 2, wherein at least one of the electrodes comprises a metal selected from the group consisting of iron (Fe), magnesium (Mg), zinc (Zn), nickel (Ni), copper (Cu), Aluminium (Al), titanium (Ti), or an alloy thereof.

5. The method according to claim 3, wherein at least one of the electrodes comprises iron (Fe) and the and the first gas stream comprises at least one contaminant gas that is carbon dioxide (CO₂), wherein the one or more reaction products formed comprises a slurry of iron (II) carbonate (FeCO₃), which is separated from the working fluid; and wherein the second gas stream has less than 30 wt. % CO₂.

6. (canceled)

7. The method according to claim 3, wherein at least one of the electrodes comprises iron (Fe) and the first gas stream comprises at least one contaminant gas that is hydrogen sulfide (H₂S), wherein the one or more reaction products formed comprises a slurry of iron (II) sulfide (FeS), which is separated from the working fluid, and wherein the second gas stream has less than 1000 ppmv H₂S.

8. (canceled)

9. The method according to claim 3, wherein the first gas stream comprises at least one contaminant gas that is ammonia (NH₃), and wherein the one or more reaction products formed comprises aqueous ammonium (NH₄⁺), at least some of which is removed from the working fluid by purging at least a portion thereof from the electrochemical cell, and wherein the second gas stream has less than 1000 ppmv NH₃.

10. (canceled)

11. The method according to claim 2, wherein at least a portion of the second gas stream is recycled back into the first gas stream.

12. (canceled)

13. The method according to claim 4, wherein the first gas stream is biogas comprising at least one contaminant gas selected from the group consisting of CO₂, H₂S, NH₃, NOx, and a halogen, and wherein the biogas is generated during anaerobic digestion of organic matter, wherein the organic matter is derived from the group consisting of sewage/wastewater, agricultural wastes, municipal wastes, manure, plant materials, green wastes and food wastes.

14. The method according to claim 4, wherein the working fluid comprises an electrolyte solution of an alkali metal or alkaline earth metal salt.

15. The method according to claim 14, wherein the alkali metal or alkaline earth metal salt is selected from the group of alkali metal or alkaline earth metals consisting of sodium (Na), potassium (K), lithium (Li), magnesium (Mg), calcium (Ca), and a mixture thereof.

16. The method according to claim 15, wherein the electrolyte is an aqueous NaCl solution, and wherein the concentration of the NaCl solution is between about 0.1% to about 5%.

17. The method according to claim 11, further comprising, prior to step a) or prior to step b), the step of:
a1) fluidly communicating at least a portion of the first gas stream having the at least one contaminant gas from a gas source to the electrochemical cell.

18. The method according to claim 17, wherein step b) comprises fluidly communicating at least a portion of the first gas stream having the at least one contaminant gas, with at least a portion of the working fluid in a gas-liquid reactor in circulating fluid communication with the electrochemical cell, wherein the plurality of electrochemically generated ions from the electrochemical cell and the at least one contaminant gas are brought into fluidic contact in the gas-liquid reactor.

19. The method according to claim 18, wherein the gas-liquid reactor is selected from a gas scrubber and a bubbling column, wherein the plurality of electrochemically generated ions and at least a portion of the first gas stream are brought into fluidic contact in a counter-current arrangement.

20-21. (canceled)

22. A system for removing a portion of at least one contaminant gas from a first gas stream, the system comprising:
an electrochemical cell comprising an electrically connected pair of electrodes at least partially in contact with a working fluid, wherein, when a voltage is applied across the electrodes, a plurality of ions is electrochemically generated in the working fluid for reacting with at least a portion of the at least one contaminant gas to convert the portion of the at least one contaminant gas to one or more reaction products, thereby sequestering at least some of the contaminant gas from the first gas stream thereby to produce a second gas stream,
wherein the pH of the working fluid is substantially maintained at a predetermined set point for improving the efficiency of the conversion.

23. (canceled)

24. A process for treating sewage or wastewater, comprising the step of:
treating sewage, wastewater, and/or a sludge derived therefrom, with iron (II) carbonate (FeCO₃), or iron (II) carbonate (FeCO₃) when produced by the method according to claim 5, to:
(i) react with one or more contaminants therein to facilitate at least the partial removal of the contaminant(s) therefrom; and/or
(ii) enhance the settling and/or dewatering performance of the sludge.
